(19) United States
(12) Patent Application Publication
(10) Pub. No.: US 2012/0223022 A1
(43) Pub. Date: Sep. 6, 2012

(54) CONTAMINANT REMOVAL FROM WATERS USING RARE EARTHS

(75) Inventors: Carl Hassler, Gig Harbor, WA (US); John Burba, Parker, CO (US); Robert Cable, Las Vegas, NV (US)

(73) Assignee: MOLYCORP MINERALS, LLC, Greenwood Village, CO (US)

(21) Appl. No.: 13/410,081

(22) Filed: Mar. 1, 2012

Related U.S. Application Data
(60) Provisional application No. 61/448,021, filed on Mar. 1, 2011.
(60) Provisional application No. 61/453,446, filed on Mar. 16, 2011.
(60) Provisional application No. 61/474,902, filed on Apr. 13, 2011.
(60) Provisional application No. 61/476,667, filed on Apr. 18, 2011.
(60) Provisional application No. 61/553,809, filed on Oct. 31, 2011.
(60) Provisional application No. 61/558,887, filed on Nov. 11, 2011.
(60) Provisional application No. 61/538,634, filed on Sep. 23, 2011.

(51) Int. Cl. C02F 1/68; C02F 1/52; C02F 9/04; C09K 3/00; A47K 3/02; C02F 101/30; C02F 101/36; C02F 101/38; C02F 101/34; C02F 101/10

(52) U.S. Cl. 210/717; 252/175; 210/767; 210/749; 210/702; 4/538

(57) ABSTRACT

The present disclosure is directed to the use of rare earth-containing additives, particularly rare earth-containing additives comprising rare earths of plural oxidation states, to remove, particularly from recreational waters, various target materials, such as disinfectant by-products and precursors thereof, phosphates, and organophosphates.

### CROSS REFERENCE TO RELATED APPLICATION

The present application claims the benefits of U.S. Provisional Application Ser. Nos. 61/448,021 with a filing date of Mar. 1, 2011, 61/453,446 with a filing date of Mar. 16, 2011, 61/474,902 with a filing date of Apr. 13, 2011, 61/476,667 with a filing date of Apr. 18, 2011, 61/538,634 with a filing date of Sep. 23, 2011, 61/553,809 with a filing date of Oct. 31, 2011, and 61/558,887 with a filing date of Nov. 11, 2011, all entitled “Process for Treating Waters and Water Handling Systems Using Rare Earth Metals”, each of which are incorporated in their entirety herein by this reference.

Cross reference is made to U.S. patent application Ser. No. 13/244,117 filed Sep. 23, 2011, entitled “PARTICULATE CERIUM DIOXIDE AND AN IN SITU METHOD FOR MAKING AND USING THE SAME” having attorney docket no. 6062-89-4, which is incorporated herein by this reference in its entirety.

Cross reference is made to U.S. patent application Ser. No. 13/356,574 filed Jan. 23, 2012, entitled “RARE EARTH REMOVAL OF PHOSPHORUS-CONTAINING MATERIALS” having attorney docket no. 6062-89-5, which is incorporated herein by this reference in its entirety.

Cross reference is made to U.S. patent application Ser. No. 13/356,581 filed Jan. 23, 2012, entitled “RARE EARTH REMOVAL OF HYDRATED AND HYDROXYL SPECIES” having attorney docket no. 6062-89-6, which is incorporated herein by this reference in its entirety.

### FIELD

The disclosure relates generally to the treatment of waters to remove target materials and particularly to treatment of waters containing disinfection by-products, disinfection by-product precursors and other target materials with rare earths.

### BACKGROUND

This disclosure relates generally to method and compositions for removing contaminants from streams and is particularly concerned with methods and compositions for removing contaminants from municipal waters, recreational waters, municipal wastewaters, drinking waters (including) municipal drinking waters, industrial waters to name a few.

Various techniques have been used to remove contaminants from such waters. Examples of such techniques include removal such materials using activated carbon, ion exchange resins, electrodialysis and precipitation using transition metals. However, these techniques are hindered by the difficulty that many harmful contaminants are not substantially removed.

### SUMMARY

These and other needs are addressed by the various aspects, embodiments, and configurations of the present disclosure.

Some embodiments include a method having the steps of receiving a water containing at least one of a disinfection by-product and a disinfection by-product precursor, and contacting the water with a rare earth-containing additive to remove at least one of the disinfection by-product and disinfection by-product precursor from the water to form a treated water. In some configurations, the water contains a halogenated disinfection by-product. Preferably, the disinfection by-product is one of a trihalomethane, haloacetic acid, haloacetonitrile, halofuranone, bromate, halonitromethane, haloamide, iodo-acid, iodo-trihalomethane, nitrosamine, and dihaloaldehyde. Preferably, the disinfection by-product precursor is one or more of t-butyl methyl ether, diazomethane, hypohalous acid, aldehyde, carboxylic acid, and chloramines.

In some embodiments, the disinfection-by-product comprises one or both of a halogenated hydrocarbon and halogenated carboxylic acid.

In some configurations, the halogenated hydrocarbon comprises one or more of a halogenated methane, chloradane, toxaphene, trihalomethane, endrin, heptachlor, hexachlorocyclopentadiene, hexachlorobutadiene, lindane, aldrin and dieldrin.

In some configuration, the halogenated carboxylic acid comprises one or more of halogenated acetic acid, trihaloacetic acid, trichloroacetic acid, tribromoacetic acid, triiodoacetic acid, 2,4-D, dalapon, picloram, and dicamba.

In some configurations, the rare earth-containing additive removes at least most of the disinfection by-product. In some configurations, the rare earth-containing additive removes at least most of the disinfection by-product precursor. In some configurations, the rare earth-containing additive removes at least most of the disinfection by-product and at least most of the disinfection by-product precursor.

In some configurations, the rare earth-containing additive is a water soluble cerium (III) salt. In some configurations, the rare earth-containing additive is a cerium (IV)-containing composition.

In some embodiments, the rare earth-containing additive removes at least most of target material contained in the water. Preferably, the target material is one or more of alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

In some configurations, the target material is one or both of a phosphate and an organophosphate.

In some embodiments, the disinfection-by-product comprises one or both of a halogenated hydrocarbon and halogenated carboxylic acid.

In some configurations, the halogenated hydrocarbon comprises one or more of a halogenated methane, chloradane, toxaphene, trihalomethane, endrin, heptachlor, hexachlorocyclopentadiene, hexachlorobutadiene, lindane, aldrin and dieldrin.

In some configuration, the halogenated carboxylic acid comprises one or more of halogenated acetic acid, trihaloacetic acid, trichloroacetic acid, tribromoacetic acid, triiodoacetic acid, 2,4-D, dalapon, picloram, and dicamba.

In some configurations, the disinfection by-product precursor comprises one or more of an aldehyde, carboxylic acid and ether.

Some embodiments include a method having the steps of receiving a water containing at least one of a disinfection by-product, disinfection by-product precursor and a target material and contacting the water with a rare earth additive to remove least one of disinfection by-product, disinfection by-product precursor and a target material from the water. Preferably, the rare earth additive comprises at least one of cerium (IV)-containing composition and a water soluble trivalent rare-earth containing composition. Preferably, the rare earth additive contains a water soluble trivalent rare earth-containing composition and a cerium (IV)-containing composition. More preferably, the rare earth additive has a molar ratio of the water soluble trivalent rare earth-containing composition to the cerium (IV)-containing composition of no more than about 1:0.5. Even more preferably, the cerium (IV)-containing composition is water insoluble and/or the trivalent rare earth-containing composition is primarily a cerium (III) salt. In some embodiments, the cerium (IV)-containing composition comprises cerium oxide (CeO₂).

In some embodiments, the contacting step further includes contacting a water soluble cerium (III)-containing additive with the water to form the cerium (IV)-containing composition in the water. The cerium (IV) composition is preferably formed by at least one of the following steps: (i) contacting the cerium (III)-containing additive with ozone; (ii) contacting the cerium (III)-containing additive with ultraviolet radiation; (iii) electrolyzing the cerium (III)-containing additive; (iv) contacting the cerium (III)-containing additive with free oxygen and hydroxyl ions; (v) aerating the cerium (III)-containing additive with molecular oxygen; and (vi) contacting the cerium (III)-containing additive with an oxidant. The oxidant is preferably one or more of chlorine, bromine, iodine, chloroamine, chlorine dioxide, hypochlorite, trihalomethane, haloacetic acid, hydrogen peroxide, peroxygen compound, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, and monopersulfate.

In some configurations, the target material is one or both of a phosphate and an organophosphate.

In some embodiments, the disinfection-by-product comprises one or both of a halogenated hydrocarbon and halogenated carboxylic acid.

In some configurations, the halogenated hydrocarbon comprises one or more of a halogenated methane, chloradane, toxaphene, trihalomethane, endrin, heptachlor, hexachlorocyclopentadiene, hexachlorobutadiene, lindane, aldrin and dieldrin.

In some configuration, the halogenated carboxylic acid comprises one or more of halogenated acetic acid, trihaloacetic acid, trichloroacetic acid, tribromoacetic acid, triiodoacetic acid, 2,4-D, dalapon, picloram, and dicamba.

In some configurations, the disinfection by-product precursor comprises one or more of an aldehyde, carboxylic acid and ether.

In some configurations, the target material is at least one of a disinfection by-product and a disinfection by-product precursor. Preferably, the disinfection by-product is one of a trihalomethane, haloacetic acid, haloacetonitrile, halofuranone, bromate, halonitromethane, haloamide, iodo-acid, iodo-trihalomethane, nitrosamine, and dihaloaldehyde. Preferably, the disinfection by-product precursor is one or more of t-butyl methyl ether, diazomethane, hypohalous acid, aldehyde, carboxylic acid, and chloramines.

In some configurations, the target material is one or more of alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

In some configurations, the rare earth additive contains a water soluble trivalent rare earth-containing composition and a nitrogen-containing material.

Some embodiments include a composition having a rare earth and an oxyanion. The composition has a molar ratio of the rare earth to oxyanion of about 1:1.3 to about 1:2.6. Preferably, the rare earth is cerium and the oxyanion is phosphate.

Some embodiments include a human bathing system having a rare earth-containing additive and a water recirculation system operable to treat and recirculate water to the at least one of a pool, spa, and hot tub. Preferably, the water is substantially free of a halogenated antimicrobial additive. The rare earth-containing additive preferably removes phosphates and microbes from the re-circulated water.

In some configurations, the system includes one or both of make-up and fill-waters to one of fill or replenish the human bathing system. The one or both of the make-up and fill-waters preferably contains at least one target material. More preferably, the rare earth-containing additive removes at least most of the least one target material. The at least one target material may be one or more of a disinfection by-product, a disinfection by-product precursor, a phosphate, oxyanion, organophosphate, trihalomethane, iodo-trihalomethane, haloacetic acid, halofuranone, bromate, halonitromethane, haloamide, iodo-acid, nitrosamine, dihaloaldehyde, alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

In some configurations, the target material is one or both of a phosphate and an organophosphate.

In some configurations, the halogenated hydrocarbon comprises one or more of a halogenated methane, chloradane, toxaphene, trihalomethane, endrin, heptachlor, hexachlorocyclopentadiene, hexachlorobutadiene, lindane, aldrin and dieldrin.

In some configuration, the halogenated carboxylic acid comprises one or more of halogenated acetic acid, trihaloacetic acid, trichloroacetic acid, tribromoacetic acid, triiodoacetic acid, 2,4-D, dalapon, picloram, and dicamba.

In some configurations, the disinfection by-product precursor comprises one or more of an aldehyde, carboxylic acid and ether.

In some configurations, the rare earth-containing additive contains water-insoluble cerium (IV). Preferably, the water-insoluble cerium (IV) is cerium oxide (CeO₂).

In some configurations, the rare earth-containing additive contains cerium (IV) oxide. Preferably, the rare earth-containing additive is cerium (IV) oxide and/or an agglomerated cerium (IV) oxide.

According to some embodiments, the rare earth-containing additive removes one or both of sun tan oils and body oils. The present disclosure can provide a number of advantages depending on the particular configuration. For example, the rare earth-containing additives disclosed herein can remove phosphates effectively, thereby eliminating a food source for algal formation. The rare earth-containing additives can include, when added, or form in situ a mixture of differing oxidation states and/or valence numbers, such as trivalent and tetravalent rare earths, thereby enabling synergistic removal of a broader array of target materials than would be possible with either rare earth in isolation. The target materials removed, for example, could include not only phosphates by the trivalent rare earth but also organophosphates, disinfection by-products (“DBPs”), DBP precursors, and other target materials by the tetravalent rare earth. It is further believed that the trivalent and/or tetravalent rare earth can itself remove or catalyze the removal of chloramines. The tetravalent rare earth can kill pathogens and other microbes present in the water to be treated, thereby preventing the spread of disease. The rare earth-containing additive can provide for a halogen-free pool, spa or hot tub through a high efficacy in removing target materials, particularly living organisms. The rare earth-containing additive can inhibit damage to the pool, hot tub, or spa by removing bio-films and chemical deposits from the water recirculation system. The rare earth-containing additive can obviate the need to perform “shock” treatment on the pool, spa or hot tub. The rare earth-containing additive can be substantially harmless to humans and obviate the use of or remove materials that can cause bather discomfort or irritation, particularly skin and eye irritation.

These and other advantages will be apparent from the disclosure of the aspects, embodiments, and configurations contained herein.

The term “a” or “an” entity generally refers to one or more of that entity. As such, the terms “a” (or “an”), “one or more” and “at least one” can be used interchangeably herein. It is also to be noted that the terms “comprising”, “including”, and “having” can be used interchangeably.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

“Absorption” generally refers to the penetration of one substance into the inner structure of another, as distinguished from adsorption.

“Adsorption” generally refers to the adherence of atoms, ions, molecules, polyatomic ions, or other substances of a gas or liquid to the surface of another substance, called the adsorbent. Typically, the attractive force for adsorption can be, for example, ionic forces such as covalent, or electrostatic forces, such as van der Waals and/or London's forces.

The terms “agglomerate” and “aggregate” generally refers to a composition formed by gathering one or more materials into a mass.

A “binder” generally refers to one or more substances that bind together a material being agglomerated. Binders are typically solids, semi-solids, or liquids. Non-limiting examples of binders are polymeric materials, tar, pitch, asphalt, wax, cement water, solutions, dispersions, powders, silicates, gels, oils, alcohols, clays, starch, silicates, acids, molasses, lime and lignosulphonate oils, hydrocarbons, glycerin, stearate, polymers, wax, or combinations thereof. The binder may or may not chemically react with the material being agglomerated. Non-liming examples of chemical reactions include hydration/dehydration, metal ion reactions, precipitation/gelation reactions, and surface charge modification.

“Biological material” generally refers to one or both of organic and inorganic materials. The biological material may comprise a nutrient or a nutrient pathway component for one or more of the bacteria, algae, virus and/or fungi. The nutrient or the nutrient pathway component may be one of a phosphate, a carboxylic acid, a nitrogen compound (such as, ammonia, an amine, or an amide), an oxyanion, a nitrite, a toxin, or a combination thereof.

The term “carbon-containing radical”, such as R¹, R², R³ or such, generally refers to one or more of: a C₁ to C₂₅ straight-chain, branched aliphatic hydrocarbon radical; a C₅ to C₃₀ cycloaliphatic hydrocarbon radical; a C₆ to C₃₀ aromatic hydrocarbon radical; a C₇ to C₄₀ alkylaryl radical; a C₂ to C₂₅ linear or branched aliphatic hydrocarbon radical having interruption by one or more heteroatoms, such as, oxygen, nitrogen or sulfur; a C₂ to C₂₅ linear or branched aliphatic hydrocarbon radical having interruption by one or more functionalities selected from the group consisting essentially of a carbonyl (—C(O)—), an ester (—C(O)O—), an amide (—C(O)NH₀₋₂—), a C₂ to C₂₅ linear or branched aliphatic hydrocarbon radical functionalized with one or more of Cl, Br, F, I, NH_{(1or 2)}, OH, and SH; a C₅ to C₃₀ cycloaliphatic hydrocarbon radical functionalized with one or more of Cl, Br, F, I, NH_{(1or 2)}, OH, and SH; and a C₇ to C₄₀ alkylaryl radical radical functionalized with one or more of Cl, Br, F, I, NH_{(0, 1 or 2)}, OH, and SH.

The term “contacting” generally refers to any method, mode, and/or modality for brining one material in contact with another, and can include without limitation direct addition of one to the other, adding a first fluid containing the one material to the other, forming the first material in the presence of the other, the converses of the proceeding, and the combinations thereof.

The phrase “a chemical transformation” and variations thereof generally refers to process where at least some of a material has had its chemical composition transformed by a chemical reaction. “A chemical transformation” differs from “a physical transformation”. A physical transformation generally refers to a process where the chemical composition has not been chemically transformed but a physical property, such as physical size or shape, has been transformed.

A “composition” generally refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

The term “contained within the water” generally refers to materials suspended and/or dissolved within the water. The suspended material has a particle size. Suspended materials are substantially insoluble in water and dissolved materials are substantially soluble in water.

The term “deactivate” or “deactivation” includes rendering a target material, nontoxic, non-harmful, or nonpathogenic to humans and/or other animals, such as, for example, by killing the microorganism.

“Detoxify” or “detoxification” includes rendering a chemical contaminant non-toxic to a living organism, such as, for example, a human and/or other animal. The chemical contaminant may be rendered non-toxic by converting the contaminant into a non-toxic form or species.

A “Disinfection By-Product” or DBP forms when organic and inorganic matter in water reacts with chemical treatment agents during a water disinfection process. Halogenated disinfection agents such as chlorine, bromine, iodine, chlorine dioxide or chloramine, are strong oxidizing agents introduced into water to destroy pathogenic microbes, to oxidize taste/odor-forming compounds, and to form a disinfectant residual so water is safe, that is substantially free, from microbial contamination. Residual chlorine (and other disinfectants) may also react further—both by further reactions with dissolved natural organic matter and with biological materials present in the water. By way of example, disinfectants may react with naturally present fulvic and humic acids, amino acids, and other natural organic matter, as well as iodide and bromide ions, to produce a range of DBPs such as the trihalomethanes (THMs), haloacetic acids (HAAs), haloacetonitriles, halofuranones, chlorite halonitromethanes, haloamides, iodo-acids, iodo-THMs, nitrosamines, and others to name a few.

The term “enzyme” generally refers to a protein that catalyzes (i.e., increase the rates of) chemical reactions. In enzymatic reactions, the molecules at the beginning of the process, called substrates, are converted into different molecules, called products. Enzymes are generally globular proteins and range from just 62 amino acid residues in size, for the monomer of 4-oxalocrotonate tautomerase, to over 2,500 residues in the animal fatty acid synthase.

The term “fluid” generally refers to a liquid, gas or a mixture of a liquid and gas.

A “halogen” is a series of nonmetal elements from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F⁻), chloride (Cl⁻), bromide (Br⁻), iodide (I⁻) and astatide (At⁻).

The term “insoluble” generally refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little loss of mass. Typically, a little loss of mass generally refers to less than about 5% mass loss of the insoluble material after a prolonged exposure to water.

“Microbe”, “microorganism”, and “biological contaminant” generally refers to any microscopic organism, or microorganism, whether pathogenic or nonpathogenic to humans, including, without limitation, prokaryotic and eukaryotic-type organisms, such as the cellular forms of life, namely bacteria, archaea, and eucaryota and non-cellular forms of life, such as viruses. Common microbes include, without limitation, bacteria, fungi, protozoa, viruses, prion, parasite, and other biological entities and pathogenic species. Specific non-limiting examples of bacteria include Escherichia coli, Streptococcus faecalis, Shigella spp, Leptospira, Legimella pneumophila, Yersinia enterocolitica, Staphylococcus aureus, Pseudomonas aeruginosa, Klebsiella terrigena, Bacillus anthracis, Vibrio cholrae, Salmonella typhi, of viruses, include hepatitis A, noroviruses, rotaviruses, and enteroviruses, and of protozoa include Entamoeba histolytica, Giardia, Cryptosporidium parvum.

“Organic carbons” or “organic material” generally refers to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. In some embodiments, the target material is an organic material as defined herein. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (in the form without limitation a ketone, aldehyde, carboxylic acid, ester, amide, acyl halide, acid ahydride or combinations thereof). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Commonly, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium. Other organic materials include non-living carbon-containing materials, such as aroma chemicals (that is chemicals having an odor), personal care chemicals (such as, but not limited to sun tan lotion, sun screen lotion, hair-care products, and skin-care products), pharmaceuticals (for humans and/or animals), human and/or animal hormones or growth agents or factors, caffeine, nicotine and other stimulants ingested by animals, pollutants (such as, but not limited to sweat, body oils, urine and fecal matter (human and non-human), decaying organic matter, tree sap, and pollen, oxalates, amino acids, and mixtures thereof.

The term “organophorous” generally refers to a phosphorus-containing compound containing one or more carbon-phosphorus bonds. Non-limiting examples of organophosphorus compounds include: phosphate and thiophosphyoryl esters, thioesters and amides (such as, mono-, di- and tri-phosphate esters, thioesters and amides (P(═Y)(OH)₂(XR), P(═Y)(OH)(XR)₂, and P(═Y)(XR)₃, where X can be one of oxygen, sulfur or nitrogen, Y can be one of oxygen, sulfur, selenium or tellurium and R can be a C₁-C₁₂ alkyl or aryl group), trimeyl phosphate, triethyl phosphate, tripropyl phosphate, tributyl phosphate, diazinon, phosphatidylcholine, malathion, cyclophosphamide, triphyenylphosphate and dithiophosphate); phosphonic and phosphinic acids and their esters (such as, phosphonate esters (R¹P(═O)(OR²)(OR³) and R¹R²P(═O)(OR³), where R may be hydrogen or a C₁-C₁₂ alkyl or aryl group), dimethyl phosphinic acid, diethyl phosphinic acid, dipropyl phosphinic acid, dibutyl phosphinic acid, dipentyl phosphinic acid, dihexyl phosphinic acid, methyl methylphosphonate, methyl ethylphosphonate, methyl propylphosphonate, ethyl methylphosphonate, ethyl ethylphosphonate, ethyl propylphsophonate, ethyl butylphosphonate, glyphosates, bisphosphates, and phosphinates (R₂P(═O)(OR′)); phosphine oxides (such as phosphine oxides (R₃P═O) and related P—N amino compounds, phospho-imides (R₃PNR′), chalcogenides (such as, R₃PE, where E=S, Se, or Te); phosphonium salts and phosphoranes (such as, PR₄⁺, and ylides), phosphites (such as, P(OR)₃), phosphonites (such as, P(OR)₂R′), phosphinites (such as, P(OR)R′₂), phosphines (such as, PR¹R²R³, where R¹, R² and R³ can be one of H, C₁-C₁₂ alkyl, C₁-C₁₂ aryl, C₃-C₈ cyclic, amino, ether, thio, and hydroxyl and where R¹, R² and R³ can be the same or differ), tris(dimethylamino)phosphine, a phosonocarboxylic acid or one of its ester, carboxylate or alkali and alkaline earth phosphonocarboxylates (such as XO₂P(═O)(O₂R) where X is one or more of sodium, potassium, cesium, magnesium, calcium, strontium or barium and where R is a carboxylate derived from a C₁-C₁₂ carboxylic acid), phosphonoformate and its esters and salts, and mixtures thereof. Other examples include thiophosphate and thiophosphyoryl esters, thioesters and amides (such as, mono-, di- and tri-phosphate esters, thioesters and amides (P(═Y)(OH)₂(XR), P(═Y)(OH)(XR)₂, and P(═Y)(XR)₃, where X can be one of oxygen, sulfur or nitrogen, Y can be one of oxygen and sulfur and R can be a C₁-C₁₂ alkyl or aryl group).

“Oxidizing agent”, “oxidant” or “oxidizer” generally refers to an element or compound that accepts one or more electrons from another species or agent that is oxidized.

In the oxidizing process the oxidizing agent is reduced and the other species that donates the one or more electrons is oxidized.

The terms “oxyanion” or “oxoanion” is a chemical compound with the generic formula AₓO_{y}^{z-} (where A represents a chemical element other than oxygen, O represents the element oxygen and x, y and z represent real numbers). In the embodiments having oxyanions as a chemical contaminant, “A” represents metal, metalloid, and/or non-metal elements. Examples for metal-based oxyanions include chromate, tungstate, molybdate, aluminates, zirconate, etc. Examples of metalloid-based oxyanions include arsenate, arsenite, antimonate, germanate, silicate, etc. Examples of non-metal-based oxyanions include phosphate, selemate, sulfate, etc.

The term “phosphate” generally refers to oxyanions formed from a PO₄ (phosphate) structural unit alone or linked together by sharing oxygen atoms to form a linear chain or cyclic ring structure. Non-limiting examples of phosphates are: PO₄³⁻ (phosphate); P₃O₁₀⁵⁻ (triphosphate); PₙO₃ₙ⁽ⁿ⁺²⁾⁻ (polyphosphate); P₃O₉³⁻ (cyclic trimethaphosphate); adenosine diphosphoric acid (ADPH); guanosine 5′-diphosphate 3′-dipphosphate (ppGpp); trimetaphosphate; hexametaphosphate; HPO₃²⁻ (phosphate); H₂P₂O₅²⁻ (pyrophosphites); H₂PO₂⁻ (hypophosphite); one or more of their salts, acids, esters, anionic and organophosphorus forms; and mixtures thereof.

The term “precipitation” refers not only to the removal of a contaminant in the form of insoluble species but also to the immobilization of the contaminant on or in the rare earth-containing agglomerate, the rare earth composition, rare earth-containing particle and/or the rare earth comprising the rare earth composition and/or particle. For example, “precipitation” includes processes, such as adsorption and absorption of the contaminate by the rare earth-containing agglomerate, the rare earth composition, rare earth-containing particle and/or the rare earth comprising the rare earth composition and/or particle.

The term “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

The phrases “rare earth-containing composition” and “rare earth-containing particle” generally refers to any rare earth-containing composition other than non-compositionally altered rare earth-containing minerals. In other words, as used herein “a rare earth-containing composition” and “rare earth-containing particle” exclude comminuted naturally occurring rare earth-containing minerals. However, as used herein “a rare earth-containing composition” and “rare earth-containing particles” include a rare earth-containing mineral where one or both of the chemical composition and chemical structure of the rare earth-containing portion of the mineral has been compositionally altered. More specifically, a comminuted naturally occurring bastnäsite would not be considered a rare earth-containing composition. However, a synthetically prepared bastnäsite or a rare earth-containing composition prepared by a chemical transformation of naturally occurring bastnäsite would be considered a rare earth-containing composition. The rare earth and/or rare-containing composition is, in one application, not a naturally occurring mineral but is synthetically manufactured. Exemplary naturally occurring rare earth-containing minerals include bastnäsite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth-containing composition is substantially free of one or more elements in Group 1, 2, 4-15, or 17 of the Periodic Table, a radioactive species, such as uranium, sulfur, selenium, tellurium, and polonium.

“Reducing agent”, “reductant” or “reducer” generally refers to an element or compound that donates one or more electrons to another species or agent that is reduced. In the reducing process, the reducing agent is oxidized and the other species that accepts the one or more electrons is oxidized.

The terminology “removal”, “remove” or “removing” includes the sorption, precipitation, conversion, detoxification, deactivation, and/or combination thereof of a target material contained in a water and/or water handling system.

“Soluble” generally refers to a material that readily dissolves in liquid, such as water or other solvent. For purposes of this disclosure, it is anticipated that the dissolution of a soluble material would necessarily occur on a time scale of minutes rather than days. For the material to be considered to be soluble, it is necessary that it has a significantly high solubility in the liquid such that upwards of 5 g/L of the material will dissolve in and be stable in the liquid.

“Sorb” generally refers to adsorption, absorption or both adsorption and absorption.

The term “surface area” generally refers to surface area of a material and/or substance determined by any suitable surface area measurement method. Commonly, the surface area is determined by any suitable Brunauer-Emmett-Teller (BET) analysis technique for determining the specific area of a material and/or substance.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate common and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram according to an embodiment of the present disclosure;

FIG. 2 is a plot of counts (vertical axis) against position [*2Theta] (Copper (Cu)) (horizontal axis);

FIG. 3 is a plot of removal capacity (mg PO₄/g CO₂) (vertical axis) against influent pH (horizontal axis);

FIG. 4 is a block diagram according to an embodiment of the present disclosure;

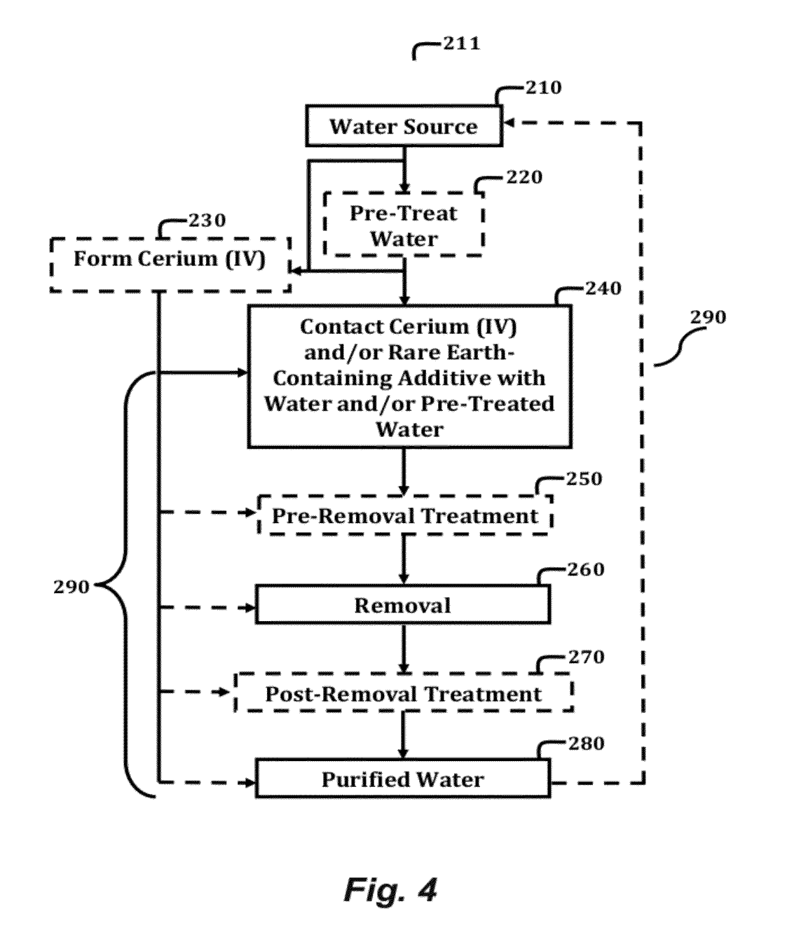

FIG. 5 is a block diagram according to an embodiment of the present disclosure;

FIG. 6 is a block diagram according to an embodiment of the present disclosure.

### DETAILED DESCRIPTION

### General Overview

The present disclosure is directed to the use of water soluble and insoluble rare earths and rare earth-containing additive to remove, chemically transform, deactivate, detoxify, and/or precipitate target materials contained within water. The target materials include oxyanions, particularly phosphate and arsenite/arsenate, microbes, living organisms, biological materials, organic materials particularly organophosphorus, chloramines (formed by the reaction of hypochlorous acid and nitrogen in ammonia), disinfection by-products and disinfection by-product precursors.

### The Target Materials

The target material in the water to be treated can include a variety of inorganic, organic, and active and inactive biological materials (such as, living and non-living biological matter). For example, the target material may be a combination, a mixture, or both a combination and mixture of one or more target materials. Furthermore, the target material can be present at any concentration. In some embodiments, the water is a pool, hot tub, or spa water.

Preferably, the target material may comprise one or more of a non-living or living material. The non-living material may comprise one or both of organic and inorganic materials. The target material can include, for example, an oxyanion; a phosphorus-containing material (such as an organophosphorous); an organic material; a microbe (such as a bacteria, virus, fungi, and algae); a biological contaminant; a biological material; or a combination or mixture thereof.

The target material may comprise a nutrient or a nutrient pathway component for one of the bacteria, algae, virus and/or fungi. While not wanting to limited by example, the nutrient or the nutrient pathway component may be one of a phosphate, a carboxylic acid, an amino acid, an lipid, a nitrogen compound (such as, ammonia, an amine, or an amide), an oxyanion, a nitrite, a nucleotide, an enzymatic cofactor, a vitamin, a phospholipid, a protein, an enzyme, an adenosine triphosphate, ADP, NAD, NADH, NAD⁺, a nucleic acid, a carbohydrate, a fat, a nitrogen-containing nutrient, a phosphorous-containing nutrient, a sulfur-containing nutrient or a combination thereof. The nutrient or nutrient pathway component can be for any microbe, plant, animal and/or human.

The target material may in some embodiments be one or more disinfection by-products or disinfection by-product precursors thereof. Exemplary disinfection by-products include trihalomethanes (THMs) (e.g., chloroform, bromoform, brominated dichloromethane (BDCM), dibrominated chloromethane (DBCM), bromo-trihalonitromethanes, iodo-trihalomethanes, bromoform, and other trihalomethanes), haloacetic acids (HAAs) (e.g., monochloro-, dichloro-, trichloro-, bromochloro-, monobromo-, and dibromoacetic acid, iodoacetic acid, and 2,4,5-TP (or 2,4,5-trichlorophyenoxy)acetic acid), haloacetonitriles, halofuranones (e.g., 3-chloro-4-(dichloromethyl)-5-hydroxy-2(5(H)-furanone (“MS”), MX (3-chloro-4-(dichloromethyl)-5-hydroxy-2(5H)-furanone and brominated forms of MX), bromate, chlorite, halonitromethanes, haloamides, iodo-acids, iodo-THMs, nitrosamines (e.g., nitrosodimethylamine (NDMA)), dihaloaldehydes, and inorganic and organic precursors and mixtures thereof. Examples of precursors include fluorine, t-butyl methyl ether, diazomethane, hypohalous acids, aldehydes (such as formaldehyde and acetaldehyde), carboxylic acids, chloramines (which can produce NDMA and iodated disinfection by-products), and the like. Many disinfection by-products form during an oxidative disinfection process, such as ultraviolet radiative water treatment or ozonation of water (which produces bromates, ketones, carboxylic acids, aldehydes, including formaldehyde, and ultimately chlorinated and brominated disinfection by-products).

Other target materials include one or more of alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), toxaphen, and mixtures thereof.

The target materials can be, in various applications, chloramines (formed by the reaction of hypochlorous acid and nitrogen in ammonia).

### Water to be Treated

The typical water to be treated system contains varying amounts of the target materials. The concentration of the target material can vary depending on the target material composition and/or form and the feed stream type, temperature, and source. Preferably, the water to be treated is in a pool, hot tub, or spa water. More preferably, the water to be treated is a in the pool, hot tub, or spa recirculation water system.

A typical water to be treated includes one or more antimicrobial additives, such as chlorine or bromine (in the form of calcium or sodium hypochlorite, hypobromite, or hypochlorous or hypobromous acid, chlorine dioxide, iodine, bromine chloride, metal cations (e.g., Cu²⁺ and Ag⁺), quaternary ammonium, potassium permanganate (KMnO₄), phenols, alcohols, quaternary ammonium salts, hydrogen peroxide, and other mineral sanitizers and disinfectants. The concentration of the antimicrobial additive commonly is at least about 0.1 mg/L, more commonly at least about 0.5 mg/L, more commonly at least about 1 mg/L and more commonly at least about 1.5 mg/L, and even more commonly at least about 2 mg/L, and commonly no more than about 10 mg/L, more commonly no more than about 7.5 mg/L, and even more commonly no more than about 5 mg/L.

A typical water to be treated further comprises commonly from about 0.01 ppm to about 1 mg/L, more commonly from about 0.1 to about 0.75 mg/L, and even more commonly from about 0.20 to about 0.5 mg/L chloramines.

A typical water to be treated further comprises commonly at least about 0.1 μg/L, more commonly at least about 2 μg/L, more commonly at least about 4 μg/L, and even more commonly at least about 5 μg/L, and commonly no more than about 1,000 μg/L, more commonly no more than about 750 μg/L, more commonly no more than about 500 μg/L, more commonly no more than about 250 μg/L, and even more commonly no more than about 125 μg/L DBPs, individually and collectively.

A typical water to be treated further includes a stabilizing agent in a concentration commonly ranging from about 0.1 to about 150 ppm, more commonly from about 25 to about 150 ppm, and even more commonly from about 30 to about 50 ppm.

A typical water to be treated further includes phosphates and/or organophosphates in a concentration of from 0.05 to about 10 ppm, more commonly from about 0.1 to about 5 ppm, and even more commonly from about 0.1 to about 2.5 ppm, individually and collectively.

The pH of the water to be treated varies. Commonly, the pH of the water to be treated may be from about pH 0 to about pH 14, more commonly the pH of the water to be treated may be from about pH 1 to about pH 13, even more commonly the pH of the water to be treated may be from about pH 2 to about pH 12, even more commonly the pH of the water to be treated may be from about pH 3 to about pH 11, yet even more commonly the pH of the water to be treated may be from about pH 4 to about pH 10, still yet even more commonly the pH of the water to be treated may be from about pH 5 to about pH 9, or still yet even more commonly the pH of the water to be treated may be from about pH 6 to about pH 8.

Typically, the water has a temperature ranging from about −5 degrees Celsius to about 50 degrees Celsius, more typically from about 0 degrees Celsius to about 45 degrees Celsius, yet even more typically from about 5 degrees Celsius to about 40 degrees Celsius and still yet even more typically from about 10 degrees Celsius to about 35 degrees Celsius. In some configurations, each of the water may a temperature of typically at least about 20 degrees Celsius, more typically at least about 25 degrees Celsius, even more typically at least about 30 degrees Celsius, yet even more typically of at least about 35 degrees Celsius, still yet even more typically of at least about 40 degrees Celsius, still yet even more typically of at least about 45 degrees Celsius, still yet even more typically of at least about 50 degrees Celsius, still yet even more typically of at least about 60 degrees Celsius, still yet even more typically of at least about 70 degrees Celsius, still yet even more typically of at least about 80 degrees Celsius, still yet even more typically of at least about 90 degrees Celsius, still yet even more typically of at least about 100 degrees Celsius, still yet even more typically of at least about 110 degrees Celsius, still yet even more typically of at least about 120 degrees Celsius, still yet even more typically of at least about 140 degrees Celsius, still yet even more typically of at least about 150 degrees Celsius, or still yet even more typically of at least about 200 degrees Celsius. In some configurations, each of the water may have a temperature of typically of no more than about 110 degrees Celsius, more typically of no more than about 100 degrees Celsius, even more typically of no more than about 90 degrees Celsius, yet even more typically of no more than about 80 degrees Celsius, still yet even more typically of no more than about 70 degrees Celsius, still yet even more typically of no more than about 60 degrees Celsius, still yet even more typically of no more than about 50 degrees Celsius, still yet even more typically of no more than about 45 degrees Celsius, still yet even more typically of no more than about 40 degrees Celsius, still yet even more typically of no more than about 35 degrees Celsius, still yet even more typically of no more than about 30 degrees Celsius, still yet even more typically of no more than about 25 degrees Celsius, still yet even more typically of no more than about 20 degrees Celsius, still yet even more typically of no more than about 15 degrees Celsius, still yet even more typically of no more than about 10 degrees Celsius, still yet even more typically of no more than about 5 degrees Celsius, or still yet even more typically of no more than about 0 degrees Celsius.

In some configurations, the temperature of the water to be treated also varies depending on the water and/or water system. Preferably, the water is one of a pool, hot tub or spa water, the temperature of the water to be treated ranges from about 65 to about 125° F., more commonly from about 75 to about 120° F., more commonly from about 80 to about 115° F., and even more commonly from about 85 to about 110° F.

In some embodiments, the waters to be treated can include without limitation municipal, industrial, and mining waste waters, drinking water, well water, natural and manmade bodies of water, pool waters, spa waters, hot tube water and the like. In some embodiments, the waters to be treated include pool waters, spa waters and/or hot tube waters

### The Rare Earth-Containing Additive

The rare earth-containing additive comprises a rare earth and/or rare earth-containing composition. The rare earth-containing additive is capable of substantially, if not entirely, removing, chemically transforming, deactivating, detoxifying, and/or precipitating target materials contained within water.

The rare earth and/or rare earth-containing composition in the rare earth-containing additive can be rare earths in elemental, ionic or compounded form. As discussed below, the rare earth and/or rare earth-containing composition can be dissolved in a solvent, such as water, or in the form of nanoparticles, particles larger than nanoparticles, agglomerates, or aggregates or combination and/or mixture thereof. The rare earth and/or rare earth-containing composition can be supported or unsupported. The rare earth and/or rare earth-containing composition can comprise one or more rare earths. The rare earths may be of the same or different valence and/or oxidation states and/or numbers, such as the +3 and +4 oxidation states and/or numbers. The rare earths can be a mixture of different rare earths, such as two or more of yttrium, scandium, cerium, lanthanum, praseodymium, and neodymium. The rare earth and/or rare earth-containing additive commonly includes cerium (III) and/or (IV), with a water soluble cerium (III) salt being more common.

The rare earth-containing composition may be water-soluble or water-insoluble. Commonly, the rare earth-containing composition comprises one or more rare earth(s) having +3, +4 or a mixture of +3 and +4 oxidation states. For example, the mixture of water soluble rare earth-containing compositions can comprise a first rare earth having a +3 oxidation state and a second rare earth having a +4 oxidation state. The first and second rare earths may have the same or differing atomic numbers. In some embodiments, the first rare earth comprises cerium (III) and the second rare earth comprises cerium (IV). In many applications, the cerium is primarily in the form of a dissociated cerium (III) salt, with the remaining cerium being present as cerium oxide.

For rare earth-containing additives having a mixture of +3 and +4 oxidations states commonly at least some of the rare earth has a +3 oxidation state, more commonly at least most of the rare earth has a +3 oxidation state, more commonly at least about 75 wt % of the rare earth has a +3 oxidation state, at even more commonly at least about 90 wt % of the rare earth has a +3 oxidation state or yet even more commonly at least about 98 wt % of the rare earth has a +3 oxidation state. The rare earth-containing additive commonly includes at least about 1 ppm, even more commonly at least about 10 ppm and yet even more commonly at least about 100 ppm cerium (IV) oxide. While in some embodiments, the rare earth-containing additive includes at least about 0.0001 wt % cerium (IV), commonly at least about 0.001 wt % cerium (IV) and even more commonly at least about 0.01 wt % cerium (IV) calculated as cerium oxide. Moreover, in some embodiments, the rare earth-containing additive commonly has at least about 250,000 ppm cerium (III), more commonly at least about 100,000 ppm cerium (III) and even more commonly at least about 20,000 ppm cerium (III).

In one formulation, the rare earth-containing additive is water-soluble and commonly includes one or more rare earths, such as cerium and/or lanthanum, the rare earth(s) having a +3 oxidation state. Non-limiting examples of suitable water soluble rare earth compounds include rare earth halides, rare earth nitrates, rare earth sulfates, rare earth oxalates, rare earth perchlorates, rare earth carbonates, and mixtures thereof.

In some formulations, the water-soluble cerium-containing additive contains, in addition to cerium, other trivalent rare earths (including one or more of lanthanum, neodymium, praseodymium and samarium). The molar ratio of cerium (III) to other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the water-soluble cerium-containing additive contains, in addition to cerium, one or more of lanthanum, neodymium, praseodymium and samarium. The water-soluble rare earth-containing additive commonly includes at least about 0.01 wt. % of one or more of lanthanum, neodymium, praseodymium and samarium. The water-soluble rare earth-containing additive commonly has on a dry basis no more than about 10 wt % La, more commonly no more than about 9 wt % La, even more commonly no more than about 8 wt % La, even more commonly no more than about 7 wt % La, even more commonly no more than about 6 wt % La, even more commonly no more than about wt % La, even more commonly no more than about 4 wt % La, even more commonly no more than about 3 wt % La, even more commonly no more than about 2 wt % La, even more commonly no more than about 1 wt % La, even more commonly no more than about 0.5 wt % La, and even more commonly no more than about 0.1 wt % La. The water-soluble rare earth-containing additive commonly has on a dry basis no more than about 8 wt % Nd, more commonly no more than about 7 wt % Nd, even more commonly no more than about 6 wt % Nd, even more commonly no more than about 5 wt % Nd, even more commonly no more than about 4 wt % Nd, even more commonly no more than about 3 wt % Nd, even more commonly no more than about 2 wt % Nd, even more commonly no more than about 1 wt % Nd, even more commonly no more than about 0.5 wt % Nd, and even more commonly no more than about 0.1 wt % Nd. The water-soluble rare earth-containing additive commonly has on a dry basis no more than about 5 wt % Pr, more commonly no more than about 4 wt % Pr, even more commonly no more than about 3 wt % Pr, even more commonly no more than about 2.5 wt % Pr, even more commonly no more than about 2.0 wt % Pr, even more commonly no more than about 1.5 wt % Pr, even more commonly no more than about 1.0 wt % Pr, even more commonly no more than about 0.5 wt % Pr, even more commonly no more than about 0.4 wt % Pr, even more commonly no more than about 0.3 wt % Pr, even more commonly no more than about 0.2 wt % Pr, and even more commonly no more than about 0.1 wt % Pr. The water-soluble rare earth-containing additive common as on a dry basis no more than about 3 wt % Sm, more commonly no more than about 2.5 wt % Sm, even more commonly no more than about 2.0 wt % Sm, even more commonly no more than about 1.5 wt % Sm, even more commonly no more than about 1.0 wt % Sm, even more commonly no more than about 0.5 wt % Sm, even more commonly no more than about 0.4 wt % Sm, even more commonly no more than about 0.3 wt % Sm, even more commonly no more than about 0.2 wt % Sm, even more commonly no more than about 0.1 wt % Sm, even more commonly no more than about 0.05 wt % Sm, and even more commonly no more than about 0.01 wt % Sm.

In some formulations, a water-soluble lanthanum-containing additive contains, in addition to cerium, other trivalent rare earths (including one or more of cerium, neodymium, praseodymium and samarium). The molar ratio of lanthanum (III) to other trivalent rare earths is commonly at least about 1:1, more commonly at least about 10:1, more commonly at least about 15:1, more commonly at least about 20:1, more commonly at least about 25:1, more commonly at least about 30:1, more commonly at least about 35:1, more commonly at least about 40:1, more commonly at least about 45:1, and more commonly at least about 50:1.

In some formulations, the rare earth-containing additive contains materials in addition to rare earth(s). For example, the rare earth-containing additive can be in the form of a solution containing a solvent in which cerium, such as a water solution containing a dissolved water-soluble cerium salt. The rare earth-containing additive can further include lead, with a maximum iron concentration being commonly no more than about 200 ppm iron, more commonly no more than about 80 ppm iron, more commonly no more than about 30 ppm iron, even more commonly no more than 20 ppm iron, yet even more commonly no more than 10 ppm iron, and still yet even more commonly no more than 1 ppm iron. The rare earth-containing additive can further include uranium, with a maximum uranium concentration being commonly no more than about 25 ppm uranium, and more commonly no more than about 10 ppm uranium. The rare earth-containing additive can further include lead, with a maximum lead concentration being commonly no more than about 100 ppm lead, more commonly from about 10 to about 50 ppm lead, more commonly from about 5 to about 10 ppm lead, and even more commonly no more than about 1 ppm lead. Higher iron levels, in particular ferric iron, can cause staining, such as staining of pools, hot tubs, fabrics, and other objects. Furthermore iron, in particular ferric iron, can cause corrosion damage to some piping systems and complicate some disinfection systems. The corrosion damage and complication with some disinfection system is primarily due to the oxidation reduction chemistry associate with ferric iron. In one for formulation, at least most of the iron is in the form ferrous iron. In another formulation, at least most of iron is in the form of ferric iron.

In some embodiments, the water-soluble rare earth-containing additive comprises one or more nitrogen-containing materials. The one or more nitrogen-containing materials, commonly, comprise one or more of ammonia, an ammonium-containing composition, a primary amine, a secondary amine, a tertiary amine, an amide, a cyclic amine, a cyclic amide, a polycyclic amine, a polycyclic amide, and combinations thereof. The nitrogen-containing materials are typically less than about 1 ppm, less than about 5 ppm, less than about 10 ppm, less than about 25 ppm, less than about 50 ppm, less about 100 ppm, less than about 200 ppm, less than about 500 ppm, less than about 750 ppm or less than about 1000 ppm of the water-soluble rare earth-containing additive. Commonly, the rare earth-containing additive comprises a water-soluble cerium (III) and/or lanthanum (III) composition. More commonly, the water-soluble rare earth-containing additive comprises cerium (III) chloride. The rare earth-containing additive is typically dissolved in a liquid.

In one formulation, the rare earth and/or rare earth-containing additive consists essentially of a water soluble cerium (III) salt, such as a cerium (III) halide, cerium perhalogenates, cerium (III) carbonate, cerium (III) nitrate, cerium (III) sulfate, cerium (III) oxalate, cerium (III) oxycarbonate, cerium (III) hydroxide, cerium (III) oxyhydroxide if applicant, and mixtures thereof. The rare earth in this formulation commonly is primarily cerium (III), more commonly at least about 75% cerium (III), more commonly at least about 80% cerium (III), more commonly at least about 85% cerium (III), more commonly at least about 90% cerium (III), and even more commonly at least about 95% cerium (III).

In another formulation, the rare earth and/or rare earth-containing additive consists essentially of a water soluble cerium (IV) salt, such as cerium (IV) sulfate (e.g., ceric ammonium sulfate and ceric sulfate), cerium (IV) nitrate (e.g., ceric ammonium nitrate), cerium (IV) oxyhydroxide, cerium (IV) hydrous oxide, and mixtures thereof. The rare earth in this formulation commonly is primarily cerium (IV), more commonly at least about 75% cerium (IV), more commonly at least about 80% cerium (IV), more commonly at least about 85% cerium (IV), more commonly at least about 90% cerium (IV), and even more commonly at least about 95% cerium (IV).

Further regarding the above embodiments, a mixture of water soluble rare earth compositions in the rare earth-containing additive having differing rare earth oxidation states may be used to remove some or all of the target material.

In another formulation, the rare earth and/or rare earth-containing additive consists essentially of a water insoluble cerium (IV) compound, particularly cerium (IV) oxide, and/or cerium (IV) oxide in combination with other rare earths (such as, but not limited to one or more of lanthanum, praseodymium, yttrium, scandium, neodymium, samarium, europium, gadolinium, terbium, dysprosium, holmium, erbium, thulium, ytterbium and lutetium). The rare earth in this formulation commonly is primarily cerium (IV), more commonly at least about 75% cerium (IV), more commonly at least about 80% cerium (IV), more commonly at least about 85% cerium (IV), more commonly at least about 90% cerium (IV), and even more commonly at least about 95% cerium (IV).

The water insoluble rare earth-containing additive may be in the form of a dispersion, colloid, suspension, or slurry of rare earth particulates. The rare earth particulates can have an average particle size ranging from the sub-micron, to micron or greater than micron. The insoluble rare earth-containing additive may have a surface area of at least about 1 m²/g. Commonly, the insoluble rare earth may have a surface area of at least about 70 m²/g. In another embodiment, the insoluble rare earth-containing additive may have a surface area from about 25 m²/g to about 500 m²/g.

The rare earth and/or rare earth-containing additive is, in one application, not a naturally occurring mineral but is synthetically manufactured. Exemplary naturally occurring rare earth-containing minerals include bastnaesite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth and/or rare earth-containing additive is substantially free of one or more elements in Group 1, 2, 4-15, or 17 of the Periodic Table, a radioactive species, such as uranium, sulfur, selenium, tellurium, and polonium.

The rare earth and/or rare earth-containing additive may be in the form of one or more of a granule, powder, crystal, crystallite, particle and particulate. Furthermore, it can be appreciated that the agglomerated and/or aggregated rare earth-containing additive may be in the form of one or more of a granule, powder, particle, and particulate.

The rare earth-containing additive may comprise crystals or crystallites and be in the form of a free-flowing granule, powder, and/or particulate. Typically the crystals or crystallites are present as nanocrystals or nanocrystallites. Typically, the rare earth powder has nanocrystalline domains. The rare earth powder may have a mean, median, and/or P₉₀ particle size of at least about 0.5 nm, ranging up to about 1 μm or more. More typically, the rare earth granule, powder and/or particle has a mean particle size of at least about 1 nm, in some cases at least about 5 nm, in other cases, at least about 10 nm, and still other cases at least about 25 nm, and in yet still other cases at least about 50 nm. In other embodiments, the rare earth powder has a mean, median, and/or P₉₀ particle size in the range of from about 50 nm to about 500 microns and in still other embodiments in the range of from about 50 nm to about 500 nm. The powder is typically at least about 75 wt. %, more typically at least about 80 wt. %, more typically at least about 85 wt. %, more typically at least about 90 wt. %, more typically at least about 95 wt. %, and even more typically at least about 99 wt. % of rare earth compound(s).

The rare earth-containing additive may be formulated as a rare earth-containing agglomerate or aggregate. The agglomerates or aggregates can be formed through one or more of extrusion, molding, calcining, sintering, and compaction. In one formulation, the rare earth-containing additive is a free-flowing agglomerate comprising a binder and a rare earth powder having nanocrystalline domains. The agglomerates or aggregates can be crushed, cut, chopped or milled and then sieved to obtain a desired particle size distribution. Furthermore, the rare earth powder may comprise an aggregate of rare earth nanocyrstalline domains. Aggregates can comprise rare earth-containing particulates aggregated in a granule, a bead, a pellet, a powder, a fiber, or a similar form.

In one agglomerate or aggregate formulation, the agglomerates or aggregates include an insoluble rare earth-containing composition, commonly, cerium (III) oxide, cerium (IV) oxide, and mixtures thereof, and a water soluble rare earth-containing composition, commonly a cerium (III) salt (such as cerium (III) carbonate, cerium (III) halides, cerium (III) nitrate, cerium (III) sulfate, cerium (III) oxalates, cerium (III) perchlorate, cerium (IV) salts (such as cerium (IV) oxide, cerium (IV) ammonium sulfate, cerium (IV) acetate, cerium (IV) halides, cerium (IV) oxalates, cerium (IV) perchlorate, and/or cerium (IV) sulfate), and mixtures thereof) and/or a lanthanum (III) salt or oxide (such as lanthanum (III) carbonate, lanthanum (III) halides, lanthanum (III) nitrate, lanthanum (III) sulfate, lanthanum (III) oxalates, lanthanum (III) oxide, lanthanum (III) perchlorate, and mixtures thereof).

The binder can include one or more polymers selected from the group consisting of thermosetting polymers, thermoplastic polymers, elastomeric polymers, cellulosic polymers and glasses. Binders include polymeric and/or thermoplastic materials that are capable of softening and becoming “tacky” at elevated temperatures and hardening when cooled. The polymers forming the binder may be wet or dry.

The common mean, median, or P₉₀ size of the agglomerate or aggregates depend on the application. In most applications, the agglomerates or aggregates commonly have a mean, median, or P₉₀ size of at least about 1 μm, more commonly at least about 5 μm, more commonly at least about 10 μm, still more commonly at least about 25 μm. In other applications, the agglomerate has a mean, median, or P₉₀ particle size distribution from about 100 to about 5,000 microns, a mean, median, or P₉₀ particle size distribution from about 200 to about 2,500 microns, a mean, median, or P₉₀ particle size distribution from about 250 to about 2,500 microns, or a mean, median, or P₉₀ particle size distribution from about 300 to about 500 microns. In other applications, the agglomerates or aggregates can have a mean, median, or P₉₀ particle size distribution of at least about 100 nm, specifically at least about 250 nm, more specifically at least about 500 nm, still more specifically at least about 1 μm and yet more specifically at least about 0.5 nm, ranging up to about 1 micron or more. Specifically, the rare earth particulates, individually and/or agglomerated or aggregated, can have a surface area of at least about 5 m²/g, in other cases at least about 10 m²/g, in other cases at least about 70 m²/g, in other cases at least about 85 m²/g, in other cases at least about 100 m²/g, in other cases at least about 115 m²/g, in other cases at least about 125 m²/g, in other cases at least about 150 m²/g, in still other cases at least 300 m²/g, and in yet other cases at least about 400 m²/g.

The agglomerate or aggregate composition can vary depending on of the agglomeration or aggregation process. Commonly, the agglomerates or aggregates include more than 10.01 wt %, even more commonly more than about 75 wt %, and even more commonly from about 80 to about 95 wt % of the rare earth-containing additive, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate or aggregate.

In another formulation, the rare earth-containing additive includes nanocrystalline rare earth particles supported on, coated on, or incorporated into a substrate. The nanocrystalline rare earth particles can, for example, be supported or coated on the substrate by a suitable binder, such as those set forth above. Substrates can include porous and fluid permeable solids having a desired shape and physical dimensions. The substrate, for example, can be a sintered ceramic, sintered metal, microporous carbon, glass fiber, cellulosic fiber, alumina, gamma-alumina, activated alumina, acidified alumina, metal oxide containing labile anions, crystalline alumino-silicate such as a zeolite, amorphous silica-alumina, ion exchange resin, clay, ferric sulfate, porous ceramic, and the like. Such substrates can be in the form of mesh, as screens, tubes, honeycomb structures, monoliths, and blocks of various shapes, including cylinders and toroids. The structure of the substrate will vary depending on the application but can include a woven substrate, non-woven substrate, porous membrane, filter, fabric, textile, or other fluid permeable structure. The rare earth and/or rare composition in the rare earth-containing additive can be incorporated into or coated onto a filter block or monolith for use in a filter, such as a cross-flow type filter. The rare earth and/or rare earth-containing additive can be in the form of particles coated on to or incorporated in the substrate or can be ionically substituted for cations in the substrate.

The amount of rare earth and/or rare earth-containing composition in the rare earth-containing additive can depend on the particular substrate and/or binder employed. Typically, the target material removal element includes at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-containing additive includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

It should be noted that it is not required to formulate the rare earth-containing additive with either a binder or a substrate, though such formulations may be desired depending on the application.

In some embodiments, a filtering device comprising an insoluble rare earth additive may remove the target material. The filter may comprise cerium dioxide, supported on or contained with a matrix comprising a polymeric material, such as, but not limited to a fluorocarbon-containing polymer. More commonly, the rare earth additive comprises cerium (4+), even more commonly, cerium dioxide.

The rare earth-containing additive can remove target materials. The rare earth-containing additive may remove target material by one or more possible mechanisms.

In accordance with some embodiments, the contacting of a soluble or insoluble rare earth cation with an oxyanion target material may remove substantially at least most of the oxyanion from a water containing the oxyanion to form a solid rare earth-containing oxyanion composition. Commonly, the rare earth cation is a rare earth +3 cation. More commonly, the +3 rare comprises one or more of cerium +3, lanthanum +3 and praseodymium +3. The oxyanion anion can be any oxyanion of an element selected from group 4, 5, 6, 7, 8, 9, 10, 11, 12, 13, 14, 15 or 16 of the periodic table. Furthermore, common oxyanions are phosphate, carbonate, sulfate, silicate, arsenate or a mixture thereof. More common oxyanions are phosphate, carbonate, silicate, arsenate or a mixture thereof. Even more common oxyanions are oxyanions are one or more of phosphate, carbonate and silicate.

While not wishing to be bound by any theory, the oxyanion is believed to be removed from solution by sorption (that is, adsorption, absorption and/or precipitation) by the rare earth-containing composition. More specifically, the oxyanion is removed from solution as an insoluble oxyanion-rare earth composition. The insoluble oxyanion-rare earth composition has a rare earth to oxyanion ratio. The rare earth to oxyanion ratio can vary depending on the solution pH value when the insoluble oxyanion-rare earth composition is formed. Generally, insoluble oxyanion-rare earth compositions having a rare earth to oxyanion ratio less than 1 have a greater molar removal capacity of oxyanion than insoluble oxyanion-rare earth compositions having a rare earth to oxyanion ratio of 1 or more than 1. In some embodiments, the greater the pH value the greater the rare earth to oxyanion ratio. In other embodiments, the greater the pH value the smaller the rare earth to oxyanion ratio. In yet other embodiment, the rare earth to oxyanion ratio is substantially unchanged over a range of pH values. In some embodiments, the rare earth to oxyanion ratio is no more than about 0.1, the rare earth to oxyanion ratio is no more than about 0.2, the rare earth to oxyanion ratio is no more about 0.3, the rare earth to oxyanion ratio is no more than about 0.4, the rare earth to oxyanion ratio is no more than about 0.5, the rare earth to oxyanion ratio is no more than about 0.6, the rare earth to oxyanion ratio is no more than about 0.7, the rare earth to oxyanion ratio is no more than about 0.8, the rare earth to oxyanion ratio is no more than about 0.9, the rare earth to oxyanion ratio is no more than about 1.0, the rare earth to oxyanion ratio is no more than about 1.1, the rare earth to oxyanion ratio is no more than about 1.2, the rare earth to oxyanion ratio is no more than about 1.3, the rare earth to oxyanion ratio is no more than about 1.4, the rare earth to oxyanion ratio is no more than about 1.5, the rare earth to oxyanion ratio is no more than about 1.6, the rare earth to oxyanion ratio is no more than about 1.7, the rare earth to oxyanion ratio is no more about 1.8, the rare earth to oxyanion ratio is no more than about 1.9, the rare earth to oxyanion ratio is no more than about 1.9, or the rare earth to oxyanion ratio is more than about 2.0 at a pH value of no more than about pH −2, at a pH value of more than about pH −1, at a pH value of more than about pH 0, at a pH value of more than about pH 1, at a pH value of more than about pH 2, at a pH value of more than about pH 3, at a pH value of more than about pH 4, at a pH value of more than about pH 5, at a pH value of more than about pH 6, at a pH value of more than about pH 7, at a pH value of more than about pH 8, at a pH value of more than about pH 9, at a pH value of more than about pH 10, at a pH value of more than about pH 11, at a pH value of more than about pH 12, at a pH value of more than about pH 13, or at a pH value of more than about pH 14.

In many applications, cerium is highly effective in removing target materials comprising phosphate. Cerium (III) phosphate (CePO₄) has a 1:1 molar ratio of cerium (III) to PO₄³⁻ and cerium (IV) phosphate (Ce₃(PO₄)₄) has a 1:1.3 ratio of cerium (IV) to PO₄³⁻. However, contacting water soluble cerium (III), derived from CeCl₃, with a phosphate-containing target material produces a cerium phosphate precipitate having a cerium to phosphate ratio from about 1:1.3 to about 1:2.6, more commonly from about 1:1.3 to about 1:1, and even more commonly from about 1:1.3 to about 1:1.5. While not wishing to be bound by any theory, it is believed that the precipitate formed by contacting a water soluble cerium (III) salt with a phosphate-containing aqueous solution (such as, but not limited to recirculating pool, hot tub, or spa water) is a mixture of CePO₄ and Ce₂(PO4)₃. The contacting of water soluble cerium (III) with a phosphate target material substantially can remove greater than expected phosphate target material based on cerium-to-phosphate stoichiometry. The cerium may be a substantially water soluble cerium-containing composition or a substantially water insoluble cerium-containing composition.

While not wishing to be bound by any theory, it is believed that rare earth-containing compositions are effective in removing a living target material by chemically interacting with the biochemical pathways associated with living target material. More specifically, it is believed that the rare earth +3 cation chemically interacts with one or both of the phosphate and carboxylate biochemistry associated with the living organism. The chemical interaction is believed to be strong enough to substantially impair and/or kill the living target material and thereby remove, deactivate, and detoxify substantially, if not entirely, the target material from or in the water recirculation system. Common rare earth +3 cations are lanthanum, cerium and praseodymium, more common rare earth +3 cations are lanthanum and cerium.

### The Water Recirculation System

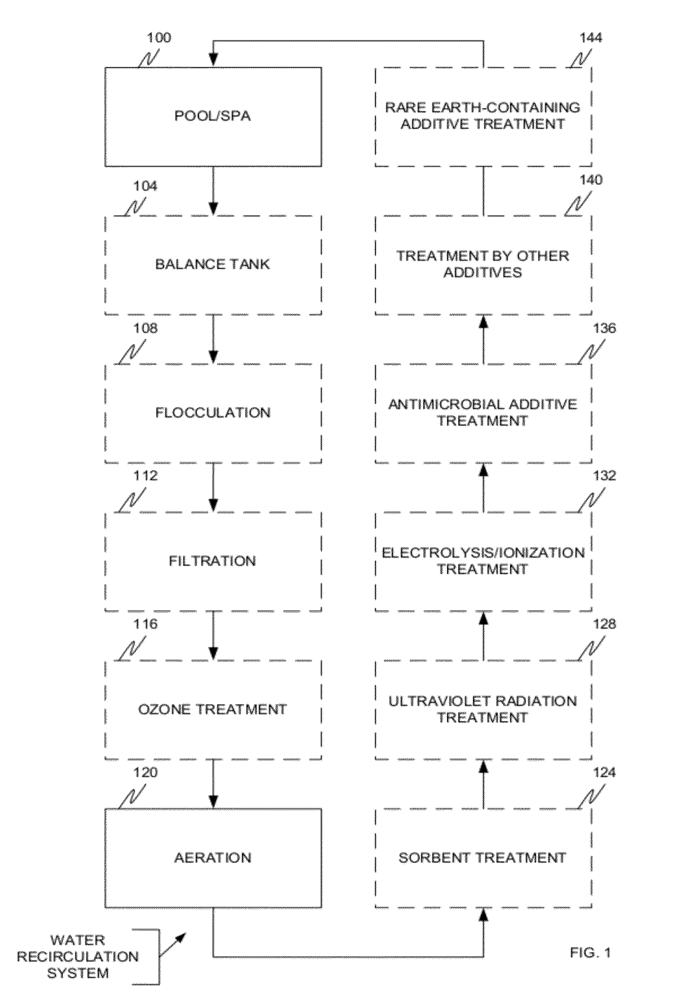

FIG. 1 depicts a typical water recirculation system for a pool, hot tub, or spa 100. Pools include above-ground, fiberglass, vinyl-lined, gunite, and poured-concrete pools. Hot tubs, spas, and therapy pools generally have hotter water than swimming and bathing pools but can have similar water treatment elements in their respective water recirculation systems. The water recirculation systems generally pump water to be treated in a continual cycle from the pool, hot tub, or spa through various water treatment elements to remove selected contaminants or target materials and back to the pool, hot tub, or spa again. The treatment elements, typically, remove dangerous pathogens, such as bacteria and viruses, and biological materials, maintain chemical balance of the water to inhibit damage to the components of the pool, hot tub, or spa and irritation of or harm the health of swimmers or bathers, and maintain water clarity. In some pool, hot tub, or spa designs, a disinfectant, such as a halogen (with chlorine being common), is used to kill pathogens. While an ordering of steps is depicted in FIG. 1, it is to be understood that the steps can be rearranged in innumerable ways to meet the requirements of a specific application. Additionally, one or more steps, other than rare earth-containing additive addition, can be omitted to meet the requirements of a specific application. Although the discussion is this section is with respect to water recirculation systems for pool, hot tube or spa water, it is to be understood that the teachings of present disclosure can be applied to both recirculating and non-recirculating water systems and to other waters to be treated. The other waters can include without limitation municipal, industrial, mining waste-waters, clinking waters, well waters, natural and man-make bodies of waters, and the like.

Water to be treated from the pool, hot tub, or spa 100 optionally flows through one or more drains and particle removal screens (strainer baskets) (to remove debris such as leaves, suntan oil, hair, and other objects) (not shown) to a balance tank 104. The drains can be in the bottom and/or sides of the pool, hot tub, or spa 100. A balance tank 100 is used in pools that do not use skimmer boxes. The balance tank 104 stores water displaced by a swimmer's body and when the swimmer exits the pool the displaced water is returned to the pool. A pool with a balance tank maintains a substantially constant depth regardless of how many people are in the pool. The balance tank can also be fitted with an equalizing and control valve (not shown) and can be an advantageous location to dose chemicals.

Water to be treated from the balance tank 104 is contacted with one or more flocculants in step 108 to remove visible floating particles of organic matter, such as skin tissue, saliva, soap, cosmetic products, skin fats, and textile fibers, and control turbidity. As will be appreciated, flocculation is a process where colloids come out of suspension in the form of floc or flakes (which are formed by particulates clumping together). This action can differ from precipitation in that, prior to flocculation, colloids are simply suspended in a liquid and not actually dissolved in a solution. Suitable flocculants include alum, aluminum chlorohydrate, iron, aluminum chloride, calcium, magnesium, polyacrylamides, poly(acrylamide-co-acrylic acid), poly(acrylic acid), poly(vinyl alcohol), aluminum sulfate, calcium oxide, calcium hydroxide, iron (II) sulfate, iron (III) chloride, polyDADMAC, sodium aluminate, sodium silicate, chitosan, isinglass, moringa seeds, gelatin, strychnos, guar gum, and alginates.

After flocculation (step 108), the water to be treated, in filtration step 112, is passed through a filter to remove flocs, flakes and other solid material that was not removed by the strainer basket (not shown). An exemplary filter is a high-rate sand filter. Other exemplary filters include a diatomaceous earth filter or cartridge filter. Other volume and settling filters may be used.

The filtered water, in step 116, is optionally contacted with ozone (O₃) from an ozone generator. Ozone oxidizes most metals (except for gold, platinum, and indium), nitric oxide to nitrogen dioxide, carbon to carbon dioxide, and ammonia to ammonium nitrate. Ozone can decompose urea and disinfect the water to be treated. Ozone readily oxidizes cerium (III) salts to cerium (IV) oxide. Ozone can be dosed to the full recycle stream of the water to be treated or only a portion, or side stream, of the recycle stream. The concentration of ozone in the recycle stream after step 116 typically ranges from about 0.01 g/m³ to about 15 g/m³, more typically from about 0.1 g/m³ to about 10 g/m³, more typically from about 0.25 g/m³ to about 7.5 g/m³, more typically from about 0.25 g/m³ to about 5 g/m³, and even more typically from about 0.40 g/m³ to about 2.0 g/m³.

In step 120, the water to be treated is optionally aerated, such as by induced air, Aeration is performed in spas, by the venturi effect, for a massage effect of bathers. Aeration can oxidize cerium (III) to cerium (IV), preferably cerium (IV) oxide.

In optional step 124, a sorbent 124 is contacted with the water to be treated to remove selected contaminants. The sorbent 124 can be, for example, granular activated carbon, powdered activated carbon, zeolites, clays, and diatomaceous earth.

The recirculated water is, in optional step 128, contacted with ultraviolet light to kill pathogens and other microscopic and macroscopic organisms, particularly algae. As will be appreciated, ultraviolet light is electromagnetic radiation with a wavelength shorter than that of visible light, commonly in the range of from about 10 nm to about 400 nm. Ultraviolet light can be generated by an ultraviolet fluorescent lamp, ultraviolet LED, ultraviolet laser, and the like. Ultraviolet light can oxidize chemical compounds. By way of example, ultraviolet light oxidizes cerium (III) salts to cerium (IV), perferably cerium (IV) oxide. While not wishing to be bound by any theory, ultraviolet light can form an excited state or states of cerium (III) or cerium (IV) and/or trihalomethanes and DBPs to enable them to be removed by cerium (III) or cerium (IV).

The recirculated water, in optional step 132, is subjected to electrolysis and/or ionized by an ionizer. Electrolysis or ionization can form free oxygen in situ. In one configuration, oxidation is achieved by passing the water to be treated through a chamber while low voltage electric current is passed to conductive (titanium) plates in a chamber. The process causes the electro-physical separation of the water to be treated into free oxygen atoms and hydroxyl ions. This step can readily oxidize cerium (III) salts to cerium (IV) oxide.

An antimicrobial additive can optionally be added in step 136. Examples of antimicrobial additives include disinfecting agents, such as chlorine or bromine (in the form of calcium or sodium hypochlorite or hypobromite or hypochlorous or hypobromous acid), chlorine dioxide, chlorine gas, iodine, bromine chloride, metal cations (e.g., Cu²⁺ and Ag⁺), potassium permanganate (KMnO₄), phenols, alcohols, quaternary ammonium salts, hydrogen peroxide, brine, and other mineral sanitizers.

The antimicrobial additive can be added anywhere in the recirculation system. It is generally added downstream of filtration 112 using a chemical feeder or doser. Alternatively, it can be added directly to the pool using tablets in the skimmer boxes.

In optional step 140, other (non-rare-earth-containing) additives can be added. Other additives include buffers, chelating agents, water softening agents, and pool shock additives (such as high doses of potassium monopersulfate or granulated chlorine). Other additives, for example, maintain the water chemistry requirement(s), particularly the pH, total alkalinity, and calcium hardness. Pool shock additives can oxidize cerium (III) salts to cerium (IV) oxide.

The rare earth-containing additive is added in step 144, and the treated water thereafter reintroduced into the pool/spa 100. Although the rare earth-containing additive is shown as being added in a particular location, it will be understood by one of ordinary skill in the art that the rare earth-containing additive can be added anywhere in the water recirculation system. For example, the rare earth-containing additive can be added directly to the pool/spa 100, to the balance tank 104, during or after flocculation (step 198), upstream of filtration (step 112) or during filtration, such as by incorporation into the filter (not shown), before, during, or after ozone generation (step 116) or aeration (step 120), before or during sorbent treatment (step 124), such as by co-addition with the sorbent or incorporation or integration into the sorbent matrix, before, during or after ultraviolet treatment (step 128), before, during, or after electrolysis/ionization (step 132), before, during or after antimicrobial additive treatment (step 136), and before, during, or after addition of other additives (step 140).

In accordance with some embodiments, cerium (IV), typically in the form of cerium (IV) oxide, may be formed in situ, or within the water, from cerium (III) oxidation during ozone treatment (step 116), aeration (step 120), ultraviolet radiation treatment (step 128), electrolysis/ionization treatment (step 132), antimicrobial additive treatment (step 136), and treatment by other additives (step (140). Alternatively, cerium (IV) can be formed from cerium (III) by contacting an oxidant with a cerium (III) composition.

Having a mixture of +3 and +4 cerium, commonly in the form of a dissociated cerium (III) salt and a cerium (IV)-containing composition, can be advantageous. Common, non-limiting examples of cerium (IV)-containing compositions are: cerium (IV) dioxide, cerium (IV) oxide, cerium (IV) oxyhydroxide, cerium (IV) hydroxide, and hydrous cerium (IV) oxide. For example, having dissociated cerium (III) can provide for the opportunity to take advantage of cerium (III) solution sorption and/or precipitation chemistries, such as, but not limited to, the formation of insoluble cerium oxyanion compositions. Furthermore, having a cerium (IV)-containing composition presents, provides for the opportunity to take advantage of sorption and oxidation/reduction chemistries of cerium (IV), such as, the strong interaction of cerium (IV) with microbes. Moreover, the oxidation state or number of a rare earth in the rare earth-containing additive can have a significant impact on its efficacy in removing target materials. Cerium (III) and cerium (IV), for example, can have dramatically different capacities or abilities to remove target materials. Although cerium (III) and cerium (IV) both can remove phosphates, cerium (IV), and cerium (IV) oxide in particular, is generally more efficacious than cerium (III) in removing oxyanions other than phosphates, organic materials, such as organophosphorus, chloramines, and DBPs and can kill living organisms more effectively. For example, cerium (IV) oxide, but not cerium (III), can remove arsenite, and, though both cerium (IV) oxide and cerium (III) can remove arsenate, cerium (III) appears to hold arsenate more tightly than cerium (IV) oxide.

In one application, cerium (IV) is formed by contacting a first cerium-containing composition having cerium in a +3 oxidation state with an oxidant (as listed above) to form a second cerium-containing composition having cerium in a +4 oxidation state. Commonly, the second cerium-containing composition comprises CeO₂ particles. In one embodiment, the particles may have a particle size may be from about 1 nanometer to about 1000 nanometers. In another embodiment the particles may have a particle size less than about 1 nanometer. In yet another embodiment the particles may have a particle size from about 1 micrometer to about 1,000 micrometers.

Although in situ oxidation of cerium (III) salts to cerium (IV) can cause nanoparticles of cerium (IV) oxide to be formed, thereby introducing turbidity into the water to be treated, the nanoparticles can disperse through the water to be treated in the water recirculation system and collect advantageously on the filter. Turbidity may be introduced into the pool/spa 100 if cerium (IV) is formed in or upstream of the pool/spa 100 without intermediate filtration. Addition of a cerium (III) salt and oxidation of the cerium (III) to cerium (IV) can occur between the pool/spa 100 and filtration step 112 to capture finely sized particulates before they are introduced into the pool/spa 100. As noted, the filtration step 112 can be relocated or a second filtration step (not shown) introduced after rare earth-containing additive treatment for this purpose. In the latter event, the second filtration step could include a finely sized solids filter, such as a semi-permeable, partly porous, membrane filter (e.g., reverse osmosis filter, nanofilter, ultrafilter, or microfilter), a carbon block filter, or other suitable finely sized solids filter to remove at least most of the cerium (III) phosphate, cerium (IV) oxide nanoparticles, and target material-loaded cerium (IV) oxide particles from the water to be re-circulated to the pool/spa 100.

The oxidant used to convert in situ cerium (III) to cerium (IV) can be any oxidant capable of oxidizing cerium (III) to cerium (IV). Non-limiting examples of the oxidant comprise: chlorine, bromine, iodine, chloroamine, chlorine dioxide, hypochlorite, trihalomethane, haloacetic acid, ozone, ultra violet light, hydrogen peroxide, peroxygen compounds, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, monopersulfate, and combinations thereof.

In some applications, a water-soluble cerium (III)-containing additive is introduced into the water recirculation system at a location having a substantially high oxidation potential. More specifically, the water-soluble cerium (III)-containing additive and the substantially high oxidation potential is at least capable of oxidizing at least some of the cerium (III) to cerium (IV). The location within the water recirculation system having the substantially high oxidation potential may be a location where molecular oxygen (such as, oxygen gas, O₂, or air), chlorine (such as, chlorine gas, Cl₂, is introduced or generated in situ), or bromine (such as, bromine gas, Br₂, is introduced or generated in situ). Water-soluble cerium (III) contacting a highly oxidative solution can be oxidized to cerium (IV), such as CeO₂.

In some applications, a water-soluble cerium (III)-containing additive is in the water recirculation system when the pool, hot tub, or spa 100 is subjected to shock treatment, such as by using relatively high concentrations of a halogen, halide, or a halogenated oxide or a non-chlorine shock agent, particularly potassium monopersulfate. The shock treatment can oxidize the cerium (III) composition to cerium (IV) oxide. The dose normally provides a concentration of at least about 0.5 ppm, more normally at least about 1 ppm, more normally at least about 1.5 ppm, and even more normally at least about 2 ppm for potassium monopersulfate and a concentration at least about 1 ppm, more normally at least about 2 ppm, more normally at least about 3 ppm, more normally at least about 4 ppm, more normally at least about 5 ppm, more normally at least about 6 ppm, and even more normally at least about 7 ppm halogen (such as from granulated chlorine).

In some embodiments, a molar ratio of a soluble to an insoluble rare earth (which may be the same or a different rare earth) (both of which are free of or not attached to a target material) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, a molar ratio of a soluble trivalent rare earth (RE (III)) to a tetravalent insoluble rare earth (RE (IV)) (which may be the same or a different rare earth) (both of which are free of or not attached to a target material) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, a molar ratio of a soluble trivalent rare earth (RE (IV)) to a tetravalent insoluble rare earth (RE (III)) (which may be the same or a different rare earth) (both of which are free of or not attached to a target material) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, the molar ratio of cerium (III) to cerium (IV) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶.

In some embodiments, the molar ratio of cerium (IV) to cerium (III) in the water to be treated during recirculation commonly is no more than about 1:1, more commonly is no more than about 1:5×10⁻¹, even more commonly is no more than about 1:1×10⁻¹, yet even more commonly is no more than about 1:1×10⁻², still yet even more commonly is no more than about 1:1×10⁻³, still yet even more commonly is no more than about 1:1×10⁻⁴, still yet even more commonly is no more than about 1:1×10⁻⁵, or still yet even more commonly is no more than about 1:1×10⁻⁶. Further, these molar ratios apply for any combinations of soluble and insoluble forms of cerium (III) and soluble and insoluble forms of cerium (IV).

In some embodiments, a pool, hot tub, or spa is provided that is free of an anti-microbial agent (such as a halogen or halide) other than a rare earth-containing additive. The rare earth-containing additive is commonly a cerium (IV)-containing additive with cerium (IV) oxide being common. The recirculating water to be treated, for example, commonly comprises less than about 1 mg/L, even more commonly less than about 0.75 mg/L, more commonly less than about 0.5 mg/L, and even more commonly less than about 0.1 mg/L of the antimicrobial agent. Moreover, ozone treatment, aeration, ultraviolet radiation treatment, and electrolysis/ionization treatment are typically not required for adequate microbial kill levels to be realized. The rare earth-containing additive can remove not only oxyanions, particularly phosphates, and organic compounds, particularly organophosphates, but can also remove, detoxify, and/or kill living organisms, particularly microbes, such as bacteria and viruses. The rare earth-containing additive is commonly in an insoluble form incorporated into a sorbent and/or filtration system so that a substantial fraction, typically at least about 50% and more typically at least about 75% contacts or passes through the sorbent or filter containing the rare earth-containing additive. In this type of pool, hot tub, or spa, it is not believed that shock treatment is required so long as sufficient rare earth-containing additive is present to remove, chemically transform, deactivate, detoxify, and/or precipitate target materials contained within water. Although in the water recirculation system, at least most of the rare earth should be a soluble or insoluble cerium (IV) compound, with cerium (IV) oxide being common. In this pool, hot tub, or spa system, the ratio of cerium (IV) to cerium (III) commonly ranges from about 1 to about 1×10⁻⁶, more commonly from about 1 to about 1×10⁻⁵, even more commonly from about 1 to about 1×10⁻⁴, yet even more commonly from about 1 to about 1×10⁻³, still yet even more commonly from about 1 to about 1×10⁻², still yet even more commonly from about 1 to about 1×10⁻¹, still yet even more commonly from about 1 to about 5×10⁻¹, or still yet even more commonly from about 1 to about 1. The water recirculation system has the advantage of avoiding formation of chloramines and disinfection by-products (“DBPs”). More specifically, the re-circulated water is normally substantially free of DBPs and chloramines.

In other rare earth-containing additive formulations, a non-rare-earth metal or metalloid is included or added separately to reduce rare earth requirements. Such metals or metalloids include iron (III), aluminum (III), calcium (II), zirconium, and hafnium salts and mixtures thereof. The non-rare-earth metal or metalloid salt can be added before or concurrent with the use of the rare earth-containing additive. Such a mixed additive can be much less expensive than adding rare earth-containing additives alone. Certain forms of phosphate (such as phosphate anion) are removed by the non-rare-earth metal or metalloid while others (such as tripolyphosphates) are not. The molar ratio of the rare earth metal to the non-rare earth metal or metalloid is commonly no more than about 0.75 moles rare earth to about 1 mole of non-rare earth metal or metalloid, more commonly no more than about 0.50 moles rare earth to about 1 mole of non-rare earth metal or metalloid, and even more commonly no more than about 0.25 moles rare earth to aboutl mole of non-rare earth metal or metalloid.

### Water Handling Systems

The water handling system can vary depending on the water. The water can be, without limitation, any recreational water, municipal water, wastewater, well water, septic water, drinking water, naturally occurring water, swimming pool water, brine pool water, therapy pool water, diving pool water, sauna water (including steam), spa water, hot tube water, drinking water, irrigation system water, well water, agricultural process water, architectural process water, reflective pool water, water-fountain water, and water-wall water. Furthermore, the water may be derived from a municipal and/or industrial aqueous stream, municipal and/or agricultural run-off aqueous stream, septic system aqueous stream, industrial and/or manufacturing aqueous stream, medical facility aqueous stream, mining process aqueous stream, mineral production aqueous stream, petroleum production aqueous stream, recovery, and/or processing aqueous stream, evaporation pound, disposal stream, rain, storm, stream, river, lake, aquifer, estuary, lagoon, and such. The water contains one or more target materials. Preferably, the target materials comprise one or more of a disinfection by-product, disinfection by-product precursor, alachor (or 2-chloro-N-(2,6-diethylpheynyl)-N-(methoxymetyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

The water handling system components and configuration can vary depending on the treatment process, the water, and the water source. While not wanting to limited by example, the water handling systems typically include one or more of the following process units: clarifying, disinfecting, coagulating, aerating, filtering, separating solids and liquids, digesting, and polishing. The number and ordering of the process units can vary. Furthermore, some process units may occur two or more times within a water handling system. It can be appreciated that the one or more process units are in fluid communication.

The water handling system may or may not have a clarifier. Some water handling systems may have more than one clarifier, such as primary and final clarifiers. Clarifiers typically reduce cloudiness of the water by removing biological matter (such as bacteria and/or algae), suspended and/or dispersed chemicals and/or particulates from the water. Commonly a clarification process occurs before and/or after a filtration process.

The water handling system may or may not contain a filtering process. Typically, the water handling system contains at least one filtering process. Non-limiting examples of common filtering processes include without limitation screen filtration, trickling filtration, particulate filtration, sand filtration, macro-filtration, micro-filtration, ultra-filtration, nano-filtration, reverse osmosis, carbon/activated carbon filtration, dual media filtration, gravity filtration and combinations thereof. Commonly a filtration process occurs before and/or after a disinfection process. For example, a filtration process to remove solid debris, such as solid organic matter and grit from the water typically precedes the disinfection process. In some embodiments, a filtration process, such as an activated carbon and/or sand filtrations follows the disinfection process. The post-disinfection filtration process removes at least some of the chemical disinfectant remaining in the treated water.

The water handling system may or may not include a disinfection process. The disinfection process may include without limitation treating the aqueous stream and/or water with one or more of fluorine, fluorination, chlorine, chlorination, bromine, bromination, iodine, iodination, ozone, ozonation, electromagnetic irradiation, ultra-violet light, gama rays, electrolysis, chlorine dioxide, hypochlorite, heat, ultrasound, trichloroisocyanuric acid, soaps/detergents, alcohols, bromine chloride (BrCl), cupric ion (Cu²⁺), silver, silver ion (Ag⁺), permanganate, phenols, and combinations thereof. Preferably, the water handling system contains a single disinfection process, more preferably the water handling system contains two or more disinfection processes. Disinfection processes are typically provided to one of at least remove, kill and/or detoxify pathogenic material contained in the water. Typically, the pathogenic material comprises biological contaminants. According to some embodiments, one or more disinfection by-products are formed during the disinfection process.

The water handling system may or may not include coagulation. The water handling system may contain one or more coagulation processes. Typically, the coagulation process includes adding a flocculent to the water in the water handling system. Typical flocculants include aluminum sulfate, polyelectrolytes, polymers, lime and ferric chloride. The flocculent aggregates the particulate matter suspended and/or dispersed in the water, the aggregated particulate matter forms a coagulum. The coagulation process may or may not include separating the coagulum from the liquid phase. In some embodiments, coagulation may comprise part, or all, the entire clarification process. In other embodiments, the coagulation process is separate and distinct from the clarification process. Typically, the coagulation process occurs before the disinfection process.

The water handling system may or may not include aeration. Within the water handing system, aeration comprises passing a stream of air and/or molecular oxygen through the water contained in the water handling system. The aeration process promotes oxidation of contaminants contained in the water being processed by the water handling system, preferably the aeration promotes the oxidation of biological contaminates. The water handling system may contain one or more aeration processes. Typically, the disinfection process occurs after the aeration process.

The water handling system may or may not have one or more of a heater, a cooler, and a heat exchanger to heat and/or cool the water being processed by the water handling system. The heater may be any method suitable for heating the water. Non-limiting examples of suitable heating processes are solar heating systems, electromagnetic heating systems (such as, induction heating, microwave heating and infrared), immersion heaters, and thermal transfer heating systems (such as, combustion, stream, hot oil, and such, where the thermal heating source has a higher temperature than the water and transfers heat to the water to increase the temperature of the water). The heat exchanger can be any process that transfers thermal energy to or from the water. The heat exchanger can remove thermal energy from the water to cool and/or decrease the temperature of the water. Or, the heat exchanger can transfer thermal energy to the water to heat and/or increase the temperature of the water. The cooler may be any method suitable for cooling the water. Non-limiting examples of suitable cooling process are refrigeration process, evaporative coolers, and thermal transfer cooling systems (such as, chillers and such where the thermal (cooling) source has a lower temperature than the water and removes heat from the water to decrease the temperature of the water). Any of the clarification, disinfection, coagulation, aeration, filtration, sludge treatment, digestion, nutrient control, solid/liquid separation, and/or polisher processes may further include before, after and/or during one or both of a heating and cooling process. It can be appreciated that a heat exchanger typically includes at least one of heating and cooling process.

The water handling system may or may not include a digestion process. Typically, the digestion process is one of an anaerobic or aerobic digestion process. In some configurations, the digestion process may include one of an anaerobic or aerobic digestion process followed by the other of the anaerobic or aerobic digestion processes. For example, one such configuration can be an aerobic digestion process followed by an anaerobic digestion process. Commonly, the digestion process comprises microorganisms that breakdown the biodegradable material contained in the water. The anaerobic digestion of biodegradable material proceeds in the absence of oxygen, while the aerobic digestion of biodegradable material proceeds in the presence of oxygen. In some water handling systems the digestion process is typically referred to as biological stage/digester or biological treatment stage/digester. Moreover, in some systems the disinfection process comprises a digestion process.

The water handling system may or may not include a nutrient control process. Furthermore, the water handling system may include one or more nutrient control processes. The nutrient control process typically includes nitrogen and/or phosphorous control. Moreover, nitrogen control commonly may include nitrifying bacteria. Typically, phosphorous control refers to biological phosphorous control, preferably controlling phosphorous that can be used as a nutrient for algae. Nutrient control typically includes processes associated with control of oxygen demand substances, which include in addition to nutrients, pathogens, and inorganic and synthetic organic compositions. The nutrient control process can occur before or after the disinfection process.

The water handling system may or may not include a solid/liquid separation process. Preferably, the water handling system includes one or more solid/liquid separation processes. The solid/liquid separation process can comprise any process for separating a solid phase from a liquid phase, such as water. Non-limiting examples of suitable solid liquid separation processes are clarification (including trickling filtration), filtration (as described above), vacuum and/or pressure filtration, cyclone (including hydrocyclones), floatation, sedimentation (including gravity sedimentation), coagulation (as described above), sedimentation (including, but not limited to grit chambers), and combinations thereof.

The water handling system may or may not include a polisher. The polishing process can include one or more of removing fine particulates from the water, an ion-exchange process to soften the water, an adjustment to the pH value of the water, or a combination thereof. Typically, the polishing process is after the disinfection step.

While the water handling system typically includes one or more of a clarifying, disinfecting, coagulating, aerating, filtering, separating solids and liquids, digesting, and polishing processes, the water handling system may further include additional processing equipment. The additional processing equipment includes without limitation holding tanks, reactors, purifiers, treatment vessels or units, mixing vessels or elements, wash circuits, precipitation vessels, separation vessels or units, settling tanks or vessels, reservoirs, pumps, cooling towers, heat exchangers, valves, boilers, gas liquid separators, nozzles, tenders, and such. Furthermore, the water handling system includes conduit(s) interconnecting the unit operations and/or additional processing equipment. The conduits include without limitation piping, hoses, channels, aqua-ducts, ditches, and such. The water is conveyed to and from the unit operations and/or additional processing equipment by the conduit(s). Moreover, each unit operations and/or additional processing equipment is in fluid communication with the other unit operations and/or additional processing equipment by the conduits.

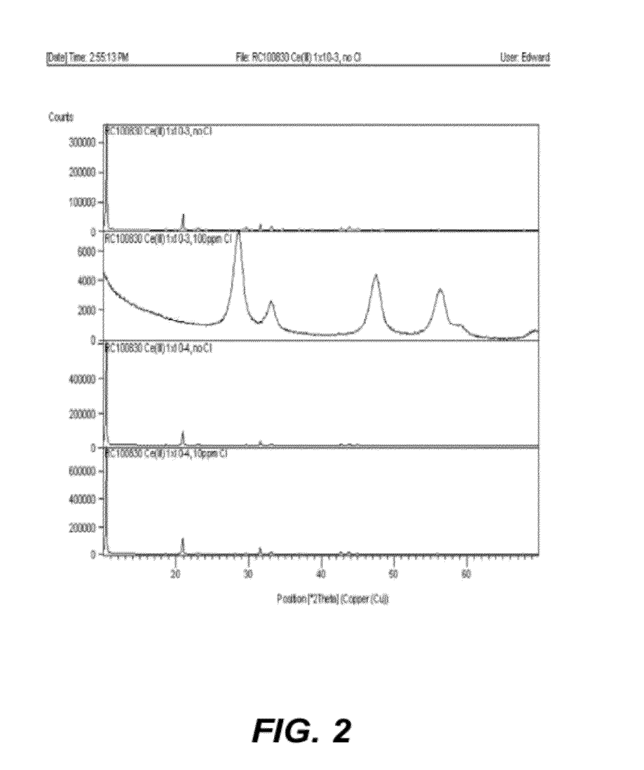

FIG. 2 depicts a process 211 for removing a target material from a water containing one or more target materials according to an embodiment.

In step 210, the water containing one or more target materials is provided to a water handling system 290. The water may be derived from any source. Non-limiting examples of suitable sources include without limitation recreational water, municipal water, wastewater, well water, septic water, drinking water, naturally occurring water sources and combinations thereof.

Step 220 is an optional step. In optional step 220, the water may be pre-treated to form a pre-treated water. The pre-treatment can comprise one or more of clarifying, disinfecting, coagulating, aerating, filtering, separating solids and liquids, digesting, and polishing processes. More specifically, the pre-treatment process can commonly comprise one of clarifying, disinfecting, coagulating, aerating, filtering, separating solids and liquids, digesting, and polishing processes, more commonly any two of clarifying, disinfecting, coagulating, aerating, filtering, separating solids and liquids, digesting, and polishing processes arranged in any order, even more commonly any three of clarifying, disinfecting, coagulating, aerating, filtering, separating solids and liquids, digesting, and polishing processes arranged in any order, yet even more commonly any four of clarifying, disinfecting, coagulating, aerating, filtering, separating solids and liquids, digesting, and polishing processes arranged in any order, still yet even more commonly any five of clarifying, disinfecting, coagulating, aerating, filtering, separating solids and liquids, digesting, and polishing processes arranged in any order, still yet even more commonly any six of clarifying, disinfecting, coagulating, aerating, filtering, separating solids and liquids, digesting, and polishing processes arranged in any order, still yet even more commonly any seven of clarifying, disinfecting, coagulating, aerating, filtering, separating solids and liquids, digesting, and polishing processes arranged in any order, still yet even more commonly any eight of clarifying, disinfecting, coagulating, aerating, filtering, separating solids and liquids, digesting, and polishing processes arranged in any order, still yet even more commonly any nine of clarifying, disinfecting, coagulating, aerating, filtering, separating solids and liquids, digesting, and polishing processes arranged in any order, still yet even more commonly any ten of clarifying, disinfecting, coagulating, aerating, filtering, separating solids and liquids, digesting, and polishing processes arranged in any order, still yet even more commonly any eleven of clarifying, disinfecting, coagulating, aerating, filtering, separating solids and liquids, digesting, and polishing processes arranged in any order, and yet still even more commonly each of clarifying, disinfecting, coagulating, aerating, filtering, separating solids and liquids, digesting, and polishing process arranged in any order. In some configurations, the pre-treatment may comprise or may further comprise processing by one or more of the additional process equipment of the water-handling system.

Step 230 is an optional step. In optional step 230, cerium (IV) is formed in one or more of the first concentration, the optionally pre-treated water, a side-stream water or a combination thereof. The side-stream water is a water stream other than the water and/or optionally pre-treated water. Preferably, the side-stream water comprises one of de-ionized water, drinking water, municipal water, water substantially free of a target material, water substantially devoid of a target material, potable water or a mixture thereof.

The cerium (IV) is formed by contacting a rare earth-containing additive with an oxidizing agent. The rare earth-containing additive comprises a rare earth and/or rare earth-containing composition comprising at least some water-soluble cerium (III). The water-soluble cerium (III) preferably comprises a water-soluble cerium (III) salt.

In some embodiments, the a rare earth-containing additive comprises in addition to the water-soluble cerium (III) composition one or more other rare earths other than cerium (III), such as, cerium (IV), yttrium, scandium, lanthanum, praseodymium, neodymium, samarium, europium, gadolinium, terbium, dysprosium, holmium, erbium, thulium, ytterbium, and lutetium. The other rare earths may or may not be water-soluble. Suitable water-soluble rare earth compositions include rare earth chlorides, rare earth bromides, rare earth iodides, rare earth astatides, rare earth nitrates, rare earth sulfates, rare earth oxalates, rare earth perchlorates, rare earth carbonates, and mixtures thereof.

In some formulations, the water-soluble cerium composition preferably comprises cerium (III) chloride, CeCl₃. In other formulations, the rare earth-containing additive comprises a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. In some formulations, the water-soluble cerium composition preferably consists essentially of cerium (III) chloride, CeCl₃. In other formulations, the rare earth-containing additive consists essentially of a water-soluble cerium (III) salt, such as a cerium (III) chloride, cerium (III) bromide, cerium (III) iodide, cerium (III) astatide, cerium perhalogenates, cerium (III) carbonate, cerium (III) nitrate, cerium (III) sulfate, cerium (III) oxalate and mixtures thereof. In some formulations, the rare earth-containing additive includes a water-soluble lanthanum (III) composition. In some formulations, the water-soluble lanthanum (III) composition preferably comprises lanthanum (III) chloride, LaCl₃. In other formulations, the rare earth-containing additive comprises a water-soluble lanthanum (III) salt, such as a lanthanum (III) chloride, lanthanum (III) bromide, lanthanum (III) iodide, lanthanum (III) astatide, lanthanum perhalogenates, lanthanum (III) carbonate, lanthanum (III) nitrate, lanthanum (III) sulfate, lanthanum (III) oxalate and mixtures thereof. In some formulations, the water-soluble lanthanum (III) composition preferably consists essentially of lanthanum (III) chloride, LaCl₃. In other formulations, the rare earth-containing additive consists essentially of a water-soluble lanthanum (III) salt, such as a lanthanum (III) chloride, lanthanum (III) bromide, lanthanum (III) iodide, lanthanum (III) astatide, lanthanum perhalogenates, lanthanum (III) carbonate, lanthanum (III) nitrate, lanthanum (III) sulfate, lanthanum (III) oxalate and mixtures thereof. In some formulation, the rare earth-containing additive includes a combination of water-soluble cerium (III) and lanthanum (III) compositions.

The rare earth and/or rare earth-containing composition in the rare earth-containing additive can comprise rare one or more earths in elemental, ionic or compounded forms dissolved in a solvent, such as water, or in the form of nano-particles, particles larger than nanoparticles, agglomerates, or aggregates or combinations and/or mixtures thereof. The rare earth and/or rare earth-containing composition can be in a supported and/or unsupported form. The rare earths may comprise rare earths having the same or different valence and/or oxidation states and/or numbers. Furthermore, the rare earths may comprise a mixture of different rare earths. Preferably, the rare earths may comprise a mixture of two or more of yttrium, scandium, cerium, lanthanum, praseodymium, and neodymium.

In some embodiments, the rare earth-containing additive comprises one or more of: an aqueous solution containing substantially dissociated, dissolved forms of the rare earths and/or rare earth-containing compositions; free flowing granules, powder, particles, and/or particulates of rare earths and/or rare earth-containing compositions containing at least some water-soluble cerium (III); free flowing aggregated granules, powder, particles, and/or particulates of rare earths and/or rare earth-containing compositions substantially free of a binder and containing at least some water-soluble cerium (III); free flowing agglomerated granules, powder, particles, and/or particulates comprising a binder and rare earths and/or rare earth-containing compositions one or both of in an aggregated and non-aggregated form and containing at least some water-soluble cerium (III); rare earths and/or rare earth-containing compositions containing at least some water-soluble cerium (III) and supported on substrate; and combinations thereof.

The oxidizing agent has substantially enough oxidizing potential to oxidize at least some of the cerium (III) to cerium (IV). The oxidizing agent comprises one or more of a chemical oxidizing agent, an oxidation process, or combination of both. Preferably, the chemical oxidizing agent comprises at least one of chlorine, chloroamines, chlorine dioxide, hypochlorites, trihalomethane, haloacetic acid, ozone, hydrogen peroxide, peroxygen compounds, hypobromous acid, bromoamines, hypobromite, hypochlorous acid, isocyanurates, tricholoro-s-triazinetriones, hydantoins, bromochloro-dimethyldantoins, 1-bromo-3-chloro-5,5-dimethyldantoin, 1,3-dichloro-5,5-dimethyldantoin, sulfur dioxide, bisulfates, and combinations thereof. In some embodiments, the chemical oxidizing agent comprises one or more of bromine, BrCl, permanganates, phenols, alcohols, oxyanions, arsenates, chromates, trichloroisocyanuric acid, and surfactants. In some configurations, the oxidizing process comprises one or more of electromagnetic energy, ultra violet light, thermal energy, ultrasonic energy, and gamma rays.

It can be appreciated that in some embodiments, disinfection by-products can be formed in step 230. While not wanting to limited by example, disinfection by-products may be formed in step 230 by the contacting of oxidizing agent with a disinfection by-product precursor.

The oxidizing agent transforms a substantially water-soluble form of cerium, preferably cerium (III), into a substantially water-insoluble form of cerium, preferably cerium (IV). In preferred embodiments, the cerium (IV) comprises one or more of cerium (IV) oxide, cerium (IV) hydroxide, cerium (IV) oxyhydroxy, cerium (IV) hydrous oxide, cerium (IV) hydrous oxyhydroxy, CeO₂, and/or Ce(IV)(O)_{w}(OH)ₓ(H₂O)_{y}.zH₂O, where w, x, y and z can be zero or a positive, real number. The cerium (IV) is preferably in the form of a colloid, suspension, or slurry of cerium (IV)-containing particulates.

In some embodiments, the cerium (IV)-containing particulates have a mean, median and/or P₉₀ particle size from about 0.1 to about 1,000 nm, more preferably from about 0.1 to about 500 nm. Even more preferably, the cerium (IV)-containing particulates have a mean, median and/or P₉₀ particle size from about 0.2 to about 100 nm. In some embodiments, the cerium (IV)-containing particulates commonly have a mean, median and/or P₉₀ particle size of less than about 1 nanometer. In other embodiments, the cerium (IV)-containing particulates have a mean, median and/or P₉₀ particle size of less than about 1 nanometer. In some embodiments, the cerium (IV)-containing particulate is in the form of one or more of a granule, crystal, crystallite, and particle.

Preferably, the cerium (IV)-containing particulates have a mean and/or median surface area of at least about 1 m²/g, more preferably a mean and/or median surface area of at least about 70 m²/g. In some embodiments, the cerium (IV)-containing particulates mean and/or median surface area from about 25 m²/g to about 500 m²/g, preferably of about 100 to about 250 m²/g.

In some embodiments, it is advantageous to have a mixture comprising cerium (IV) and a rare earth-containing additive having one or more +3 rare earths. More specifically, it is particularly advantageous to have a mixture comprising cerium (IV) and a cerium-containing additive having cerium (III) in a substantially water-soluble form. Water-soluble cerium (III) and water-insoluble cerium (IV), for example, can have dramatically different capacities and/or abilities to kill, detoxify, and/or remove target materials from a target material-containing stream. For example, having solution phase cerium (III) provides for an opportunity to take advantage of cerium (III) solution phase sorption and/or precipitation chemistries, such as, but not limited to, the formation of insoluble cerium (III) compositions with oxyanions. Furthermore, having a cerium (IV) present provides for an opportunity to take advantage of sorption and oxidation/reduction chemistries of cerium (IV), such as, the strong interaction of cerium (IV) with target materials. For example, cerium (IV) substantially removes one or both of disinfection by-products and disinfection by-product precursors. While not wanting to be limited by theory, it is believed that the cerium (IV) forms water-insoluble target material-laden cerium (IV) compositions with the disinfection by-product and/or disinfection by-product precursor.

Furthermore, cerium (IV) may substantially remove one or more of the following target materials: alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen. Moreover, it is believed that the cerium (IV) forms water-insoluble target material-laden cerium (IV) compositions with one or more of these target materials.

In some embodiments, it is advantageous to have a rare earth-containing additive comprising one or more +3 rare earths. More specifically, it is particularly advantageous to have a rare earth-containing additive comprising substantially one or more water-soluble rare earths, preferably water-soluble rare earths having a +3 oxidation state. More preferably, the rare earth-containing composition comprises cerium (III) in a substantially water-soluble form. It can be appreciated that, that in some configurations and embodiments one or more of target materials being removed and/or sorbed by cerium (IV) can be substantially removed and/or sorbed by cerium (III). That is, in some configurations, formulations and embodiments, one or more target materials can be removed from the target material-containing water by rare earth having a +3 or a rare earth having a +4 oxidation. In other words, the target material may be removed by a rare having a +3 oxidation state in the substantial absence of a rare earth having a +4 oxidation. Conversely, the target material may be removed by a rare having a +4 oxidation state in the substantial absence of a rare earth having a +3 oxidation state. The molar ratios of a +3 rare earth to a +4 rare earth, a +4 rare earth to a +3 rare earth, cerium (III) to cerium (IV) and/or cerium (IV) to cerium (III) can be the ratios presented herein above. Further, the molar ratios of cerium (III) and cerium (IV) apply for any combinations of soluble and insoluble forms of cerium (III) and soluble and insoluble forms of cerium (IV).

In accordance with some embodiments, the contacting of the rare earth-containing additive containing at least some water-soluble cerium (III) with the oxidizing agent oxidizes at least some cerium (III) to cerium (IV). Typically, the contacting of the rare earth-containing additive containing at least some water-soluble cerium (III) with the oxidizing agent oxidizes at least about 5 mole % of the water-soluble cerium (III) contained in the rare earth-containing additive to cerium (IV), more commonly at least some water-soluble cerium (III) with the oxidizing agent oxidizes at least about 10 mole % of the water-soluble cerium (III) contained in the rare earth-containing additive to cerium (IV), even more commonly at least some water-soluble cerium (III) with the oxidizing agent oxidizes at least about 20 mole % of the water-soluble cerium (III) contained in the rare earth-containing additive to cerium (IV), yet even more commonly at least some water-soluble cerium (III) with the oxidizing agent oxidizes at least about 30 mole % of the water-soluble cerium (III) contained in the rare earth-containing additive to cerium (IV), still yet even more commonly at least some water-soluble cerium (III) with the oxidizing agent oxidizes at least about 40 mole % of the water-soluble cerium (III) contained in the rare earth-containing additive to cerium (IV), still yet even more commonly at least some water-soluble cerium (III) with the oxidizing agent oxidizes at least about 50 mole % of the water-soluble cerium (III) contained in the rare earth-containing additive to cerium (IV), still yet even more commonly at least some water-soluble cerium (III) with the oxidizing agent oxidizes at least about 60 mole % of the water-soluble cerium (III) contained in the rare earth-containing additive to cerium (IV), still yet even more commonly at least some water-soluble cerium (III) with the oxidizing agent oxidizes at least about 70 mole % of the water-soluble cerium (III) contained in the rare earth-containing additive to cerium (IV), still yet even more commonly at least some water-soluble cerium (III) with the oxidizing agent oxidizes at least about 80 mole % of the water-soluble cerium (III) contained in the rare earth-containing additive to cerium (IV), still yet even more commonly at least some water-soluble cerium (III) with the oxidizing agent oxidizes at least about 90 mole % of the water-soluble cerium (III) contained in the rare earth-containing additive to cerium (IV), still yet even more commonly at least some water-soluble cerium (III) with the oxidizing agent oxidizes at least about 95 mole % of the water-soluble cerium (III) contained in the rare earth-containing additive to cerium (IV), still yet even more commonly at least some water-soluble cerium (III) with the oxidizing agent oxidizes at least about 99 mole % of the water-soluble cerium (III) contained in the rare earth-containing additive to cerium (IV), and yet still even more commonly at least some water-soluble cerium (III) with the oxidizing agent oxidizes at least about 99.9 mole % of the water-soluble cerium (III) contained in the rare earth-containing additive to cerium (IV). In can be appreciated that, the oxidation of cerium (III) to cerium (IV) can occur over a period of seconds, over a period of hours, over a period of days, or even weeks.

In step 240, the cerium (IV) formed in step 130 and/or the rare earth additive is contact with the water and/or pre-treated water to form a contaminant-laden rare earth composition and treated water. The treated water contains less of at least one of a disinfection by-product, disinfection by-product precursor, alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen than the water and/or pre-treated water.

Preferably, the cerium (IV) and/or rare earth additive is contacted with the water and/or pre-treated water in one of a clarifying, disinfecting, coagulating, aerating, filtering, separating solids and liquids, digesting, and polishing process or in a process step other than the clarifying, disinfecting, coagulating, aerating, filtering, separating solids and liquids, digesting, and polishing processes, such as in one of the addition process equipment of the water handling system 290. More preferably, the contacting of the cerium (IV) and/or rare earth additive with the water comprises one of a clarification, disinfection, coagulation, filtration, aeration, nutrient control, polisher process or combination thereof.

While not wanting to be limited by example, the clarification process can comprise contacting cerium (IV) and/or rare earth additive with the water and/or pre-treated water to remove and/or sorb a disinfection by-product, disinfection by-product precursor or target material as an aspect of the clarification process and form treated water.

In a similar manner, the coagulation process can comprise contacting cerium (IV) and/or rare earth additive with the water and/or pre-treated water to form to coagulate comprising the contaminant-laden rare earth composition.

Furthermore, the disinfection process can comprise an infectious target material to remove and/or detoxify infectious target materials-contained in one or both of the water and/or pre-treated water. It can be appreciated that, the disinfection material performing the disinfection process is preferably not removed, absorbed, precipitated, killed and/or deactivated by the cerium (IV) and/or rare earth additive.

Moreover, the filtration process can comprise contacting cerium (IV) and/or rare earth additive with the water and/or pre-treated to remove and/or sorb a disinfection by-product, disinfection by-product precursor or target material during the filtering of the water and/or pre-treated water and form treated water.

Regarding an aeration process, cerium (IV) and/or rare earth additive can be contacted with the water and/or pre-treated water to remove and/or sorb a disinfection by-product, disinfection by-product precursor or target material during aeration and form treated water.

Further regarding a digestion process, cerium (IV) and/or rare earth additive may be contacted with the water and/or pre-treated water to remove and/or sorb a disinfection by-product, disinfection by-product precursor or target material during the chemical and/or biological digestion process and form treated water. It can be appreciated that, the chemical and/or biological material is not substantially removed, absorbed, precipitated, killed and/or deactivated by the cerium (IV) and/or rare earth additive.

In one configuration, the nutrient control process can comprise contacting the cerium (IV) and/or rare earth additive with the water and/or pre-treated water. Preferably, contacting the cerium (IV) and/or rare additive with the water and/or pre-treated water removes and/or sorbs a disinfection by-product, disinfection by-product precursor or target material during the nutrient control process and forms treated water.

In some embodiments, the polishing process can comprise contacting the cerium (IV) and/or rare earth additive with the water and/or pre-treated. The contacting of the cerium (IV) and/or rare earth additive with the water and pre-treated removes and/or sorbs a disinfection by-product, disinfection by-product precursor or target material during the nutrient control process and forms treated. The treated water being polished water having a reduced target material content compared to the water and/or pre-treated water.

However, the contacting of the cerium (IV) with the one or more target materials is less preferred during a disinfection process when the cerium (IV) and/or rare earth additive can kill and/or deactivate the disinfection material. For example, cerium (IV) and/or a rare earth additive is typically not preferred with the disinfection material comprises fluorine or fluoride. Furthermore, contacting cerium (IV) and/or a rare earth additive with the water and/or pre-treated water is less preferred during some filtering and digester processes, such as trickling filtration and digestion, which are typically carried-out using microbes, particularly when the cerium (IV) and/or rare earth additive may kill and/or deactivate the microbes.

Preferably, the contaminant-laden rare earth composition is formed by contacting the cerium (IV) and/or rare earth additive with water and/or pre-treated water containing one or more of a disinfection by-product, disinfection by-product precursor and target material. The contaminant-laden rare earth composition is formed by cerium (IV) and/or rare earth additive sorbing one or more of a disinfection by-product, disinfection by-product precursor and target material. Sorbing refers to one or more of absorption, adsorption, and/or precipitation of the one or more of a disinfection by-product, disinfection by-product precursor and target material, a chemical entity of the one or more of a disinfection by-product, disinfection by-product precursor and target material and/or an oxidized form of the one or more of a disinfection by-product, disinfection by-product precursor and target material. In some embodiments, cerium (IV) and/or the rare earth additive can oxidize the target material to form an oxidized target material. In some configurations, the oxidized target material may be non-toxic. Therefore, it does not need to be removed. In some configurations, the oxidized form of the target material is easier and/or more effectively removed from the treated water. It can be appreciated that the contaminant-laden rare earth composition is a composition of matter.

Typically, the water and/or pre-treated water have a first concentration of one or more of a disinfection by-product, disinfection by-product precursor and/or target material. The treated water, respectively, has a second concentration of the one or more of a disinfection by-product, disinfection by-product precursor and/or target material. Preferably, the second concentration is less than the first concentration. Commonly, the second concentration is no more than about 0.9 of the first concentration, more commonly the second concentration is no more than about 0.8 of the first concentration, even more commonly the second concentration is no more than about 0.7 of the first concentration, yet even more commonly the second concentration is no more than about 0.6 of the first concentration, still yet even more commonly the second concentration is no more than about 0.5 of the first concentration, still yet even more commonly the second concentration is no more than about 0.4 of the first concentration, still yet even more commonly the second concentration is no more than about 0.3 of the first concentration, still yet even more commonly the second concentration is no more than about 0.2 of the first concentration, still yet even more commonly the second concentration is no more than about 0.1 of the first concentration, still yet even more commonly the second concentration is no more than about 0.05 of the first concentration, still yet even more commonly the second concentration is no more than about 0.01 of the first concentration, still yet even more commonly the second concentration is no more than about 0.005 of the first concentration, still yet even more commonly the second concentration is no more than about 0.001 of the first concentration, still yet even more commonly the second concentration is no more than about 0.5 of the first concentration, still yet even more commonly the second concentration is no more than about 0.0005 of the first concentration, still yet even more commonly the second concentration is no more than about 0.0001 of the first concentration, still yet even more commonly the second concentration is no more than about 5×10⁻⁵ of the first concentration, still yet even more commonly the second concentration is no more than about 1×10⁻⁵ of the first concentration, still yet even more commonly the second concentration is no more than about 5×10⁻⁶ of the first concentration, and still yet even more commonly the second concentration is no more than about 1×10⁻⁶ of the first concentration.

Typically, the treated water contains no more that no more than about 100,000 ppm, more typically the target material content in the treated water content is no more than about 10,000 ppm, even more typically no more than about 1,000 ppm, yet even more typically no more than about 100 ppm, still yet even more typically no more than about 10 ppm, still yet even more typically no more than about 1 ppm, still yet even more typically no more than about 100 ppb, still yet even more typically no more than about 10 ppb, still yet even more typically no more than about 1 ppb, and yet still even more typically no more than about 0.1 ppb of at least one or more of a disinfection by-product, disinfection by-product precursor and target material.

Step 250 is an optional step. In step 250, the treated water may be treated to form a further-treated water. The treatment can comprise one or more of clarifying, disinfecting, coagulating, aerating, filtering, separating solids and liquids, digesting, and polishing processes. More specifically, the treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating solids and liquids, digesting, and polishing arranged in any order. Furthermore, the treatment may or may not include contacting the treated water with cerium (IV) and/or rare earth additive to further remove any target materials contained with the treated water.

In step 260, the contaminant-laden rare earth composition is separated from one of the treated and further-treated waters to form one of a separated water and purified water. The separated water and the purified water have a third concentration of one or more of a disinfection by-product, disinfection by-product precursor and/or target material. Preferably, the third concentration is less than the second concentration. The contaminant-laden rare earth composition can be separated from the one or both of the treated and the further-treated waters by any suitable solid liquid separation process. Non-limiting examples of suitable solid liquid separation processes are clarification (including thickening) filtration (including vacuum and/or pressure filtering), cyclone (including hydrocyclones), floatation, sedimentation (including gravity sedimentation), coagulation, flocculation and combinations thereof. Furthermore, in some embodiments, the cerium (IV) and/or rare earth additive can be contacted with the treated and/or further-treated waters to remove any remaining disinfection by-product, disinfection by-product precursor and/or target material contained within the waters. When the separation process comprises a sequential series of solid liquid separations, the cerium (IV) and/or rare earth additive are preferably contacted with the waters upstream, rather downstream of the solid liquid separation processes comprising the sequential solid liquid separation series.

Step 170 is an optional step. In step 170, the separated water may be post-treated to form the purified stream. Preferably, the purified stream comprises substantially purified water. The post-treatment can comprise one or more of clarifying, disinfecting, coagulating, aerating, filtering, separating solids and liquids, digesting, and polishing processes. More specifically, the post-treatment process can commonly comprise one of clarifying, disinfecting, coagulating, aerating, filtering, separating solids and liquids, digesting, and polishing, more commonly any two of clarifying, disinfecting, coagulating, aerating, filtering, separating solids and liquids, digesting, and polishing arranged in any order, even more commonly any three of clarifying, disinfecting, coagulating, aerating, filtering, separating solids and liquids, digesting, and polishing arranged in any order, yet even more commonly any four of clarifying, disinfecting, coagulating, aerating, filtering, separating solids and liquids, digesting, and polishing arranged in any order, still yet even more commonly any five of clarifying, disinfecting, coagulating, aerating, filtering, separating solids and liquids, digesting, and polishing arranged in any order, still yet even more commonly any six of clarifying, disinfecting, coagulating, aerating, filtering, separating solids and liquids, digesting, and polishing arranged in any order, still yet even more commonly any seven of clarifying, disinfecting, coagulating, aerating, filtering, separating solids and liquids, digesting, and polishing arranged in any order, still yet even more commonly any eight of clarifying, disinfecting, coagulating, aerating, filtering, separating solids and liquids, digesting, and polishing arranged in any order, still yet even more commonly any nine of clarifying, disinfecting, coagulating, aerating, filtering, separating solids and liquids, digesting, and polishing arranged in any order, still yet even more commonly any ten of clarifying, disinfecting, coagulating, aerating, filtering, separating solids and liquids, digesting, and polishing arranged in any order, still yet even more commonly any eleven of clarifying, disinfecting, coagulating, aerating, filtering, separating solids and liquids, digesting, and polishing arranged in any order, and yet still even more commonly each of clarifying, disinfecting, coagulating, aerating, filtering, separating of solids and liquids, digesting, and polishing arranged in any order. Preferably, the post-treatment process comprises one of sand bed filtering process, clarifying process, polishing process, separating of solids and liquids, or combination thereof. More preferably, the post-treatment process comprises sand bed filtering. Furthermore, the post-treatment may or may not include contacting the separated water with cerium (IV) and/or rare earth additive to further remove any one or more of a disinfection by-product, disinfection by-product precursor and target material contained with the separated water.

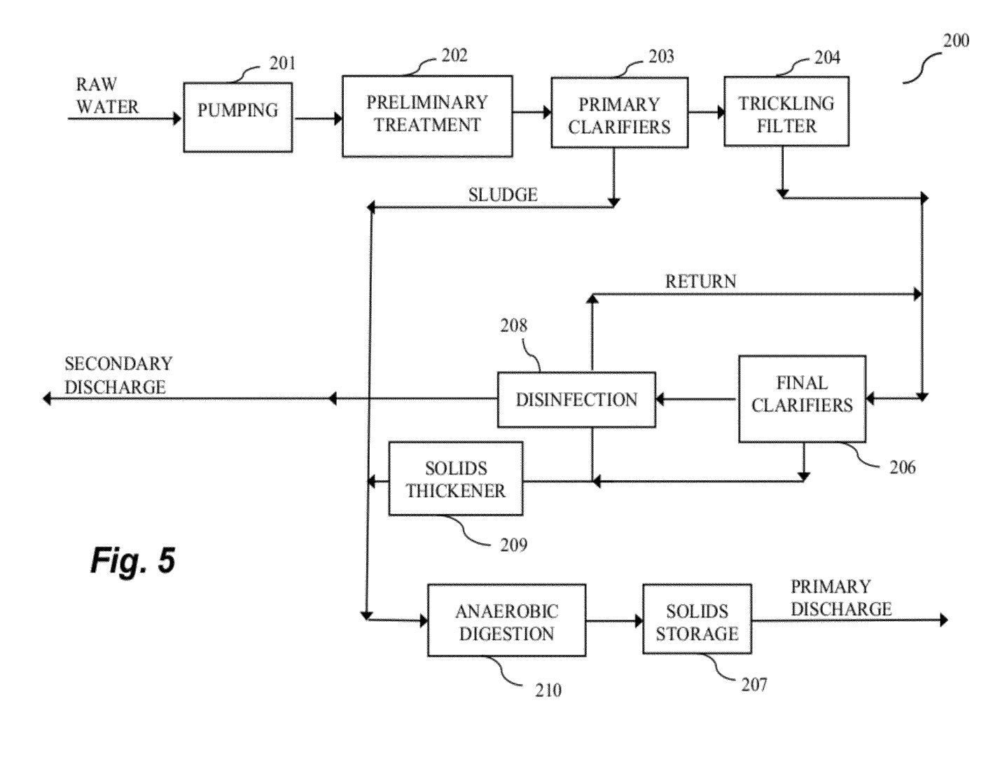

FIG. 5 depicts a typically wastewater water handling system 200 for treating water. The wastewater handling system 200 comprises one or more of a pumping process 201, preliminary treatment process 202, primary clarifier process 203, trickling filter process 204, final clarifier process 206, disinfection process 208, solid thickener 209, anaerobic digestion process 210, and solid storage process 207. It can be appreciate that the one or more a pumping 201, preliminary treatment 202, primary clarifier 203, trickling filter 204, final clarifier 206, disinfection 208, solid thickener, anaerobic digestion 210, and solid storage 207 processes are in fluid communication. The water may be municipal water, municipal and/or industrial wastewater, a well water, a septic water, a drinking water, a naturally occurring water, municipal and/or agricultural run-off water, water from an industrial and/or manufacturing process, medical facility water, water associated with a mining process, water associated with a mineral production and/or recovery process, evaporation pound water, non-potable water, or a mixture thereof.

Typically, the water is transported from its source to the preliminary treatment process 202 by pumping process 201. The pumping process 201 can be any type of fluid pumping or transporting process. The transporting process can include gravity free, trucking, piping, or any other fluid transporting processes. The preliminary treatment process 202 may include one or more of pH adjustment, filtration process, solid/liquid separating process, temperature adjustment, or such to form pre-treated water. The preliminary treatment process 202 substantially prepares and conditions the water for the primary clarifier 203. The primary clarifier 203 is typically a coagulation process to remove particles suspended in the pre-treated water. Coagulation and/or flocculation chemicals are added to the pre-treated water to form a coagulum comprising the coagulation and/or flocculation chemicals and the particles. The coagulum is suspended in the pre-treated water.

After the clarifier 203 the water containing the coagulum suspended in the pre-treated water is transferred to one or both of a secondary discharge and further treatment process. The further treatment process comprises the trickling filter 204 and/or anaerobic digestion 210 processes. Typically, the trickling filter 204 and anaerobic digestion 210 processes comprises microbes that removed contaminants from the pre-treated water. The trickling filter 204 typically comprises microbes attached to a support such as sand, gravel, pebbles or other support material. The anaerobic digestion process 201 contains bacteria and/or other microbes that consume contaminants in the absence of oxygen to form a digested-water. The digested-water is transferred to a solids storage process 207. Typically, the solid storage process 207 is a solids/liquid separation process that separates coagulum and other solids contained in the digested-water to form primary water for discharge. The primary water is typically suitable for land application.

Returning to the trickling filter 204, the support can remove the coagulum and the microbes, such as bacteria and algae remove organic and inorganic contaminants to form a filtered-water. The first-filtered water is transferred to final clarifier process 206. The filtered-water contains particles suspended within it. The final clarifier is similar to the primary clarifier, that is coagulation and/or flocculation chemicals are added to the filtered-water to form a final coagulum comprising the coagulation and/or flocculation chemicals and the particles. The final coagulum is separated from the filter-water in the final clarifier to form a separated-coagulum and clarified water.

The clarified water is transferred to disinfection process 208. The disinfection process 208 can be any disinfection process. The disinfection process 208 kills any bacteria and/or microorganism in the water to form disinfected water. In some embodiments, disinfected water is transferred to secondary discharge. In some embodiment, the disinfected water is transferred to the anaerobic disgestion process 210 to be further treated and form a primary discharge. In some embodiments, the disinfected water is transferred to the final clarifier for further clarification.

Returning to the separated coagulum formed in the final clarifier, the separated coagulum is transferred to the solids thickener process 209. The solids thickener process 209 is a solids/liquid separation process that separates coagulum and other solids for a sludge and a substantially sludge-free water. The substantially sludge-free can be discharged a second discharge water or transferred to the anaerobic digestion process 210.

The rare earth-containing additive and/or cerium (IV) is preferably contacted with the water prior to, during and/or after one or more of the pumping process 201, the preliminary treatment process 202, the primary clarifier process 203, the final clarifier process 206, the solids thickener process 209, and the solids storage process 207 to remove and/or detoxify one or more disinfection by-product, disinfection by-product precursor and target material contained in the water being processed by the handling system 200 to remove and/or sorb one or more of a disinfection by-product, disinfection by-product precursor and target material from the water being processed. It can be appreciated that the any rare earth-containing additive and/or cerium (IV) contained in the water should preferably be substantially removed from the water prior to disinfection process 208, trickling filter process 204, and/or anaerobic digestion process 210 when the microbes and/or disinfection process disinfecting agent can be killed, destroyed and/or deactivated by one or both of the rare earth-containing additive and cerium (IV). However, the rare earth-containing additive and/or cerium can be contacted with the water prior to and/or during the disinfection process if the disinfecting agent is not removed and/or sorbed by the rare earth-containing additive and/or cerium (IV). Moreover, the rare earth-containing additive and/or cerium (IV) can be contacted with the water prior to the anaerobic digestion process 210 and/or trickling filter process 204 if the microbes and/or algae are not killed, destroyed, precipitated and/or sorbed by the rare earth-containing additive and/or cerium (IV). Additionally, one or more steps, other than rare earth-containing additive addition and/or cerium (IV), can be omitted to meet the requirements of a specific application. Furthermore, the cerium (IV) may or may not formed by an in situ process in any one or more the pumping process 201, preliminary treatment process 202, primary clarifier process 203, trickling filter process 204, final clarifier process 206, disinfection process 208, solid thickener 209, anaerobic digestion process 210, and solid storage process 207.

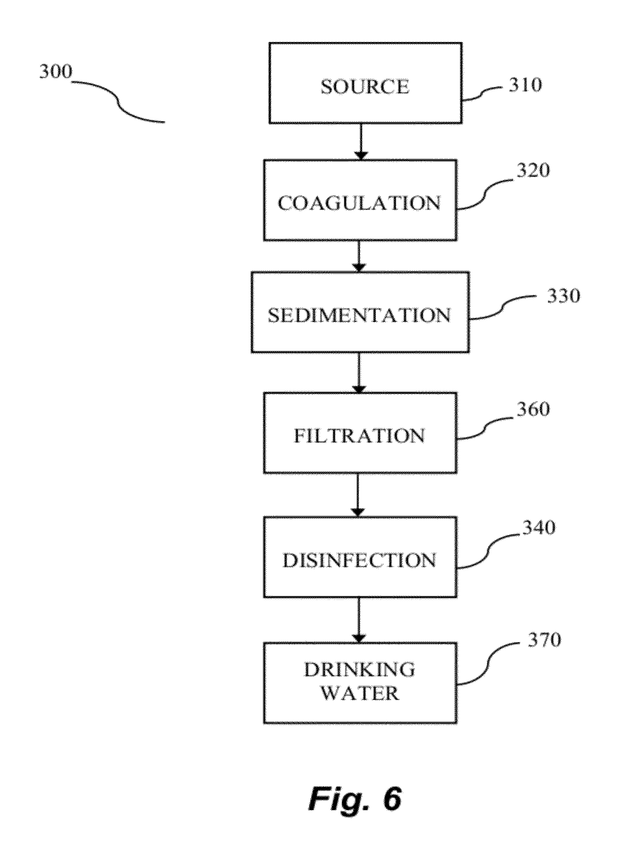

FIG. 6 depicts a typical municipal drinking water handling system 300 for treating water to form purified drinking water. The water handling system 300 includes providing the water, in step 310, and one or more of coagulation process 320, disinfection process 340, sedimentation process 330, and filtration process 360. It can be appreciated that the one or more of coagulation 320, disinfection 340, sedimentation 330, and filtration 360 processes are in fluid communication. The water be one or more of a river, lake, well, raw or treated waste, aquifer, ground water, or mixture thereof.

The coagulation process 320 removes dirt and other particles suspended in the water. Alum and/or other coagulation/flocculation chemicals are added to the water to form a coagulum and/or flocculated particles comprising the coagulation/flocculation chemicals and the dirt and/or other particles. The coagulum and/or flocculated particles are suspended in the water. After the coagulation process 320 the water containing the coagulum and/or flocculated particles suspended in the water is transferred to the sedimentation process 330. It can be appreciated that, the coagulation 320 and sedimentation 330 processes are in fluid communication. The sedimentation process comprises a solids/liquid separation process. More specifically, the coagulum and/or flocculated particles are typically denser than the water. The denser coagulum and/or flocculated particles settle to the bottom of the sedimentation vessel and a substantially sediment-free water is formed.

The substantially sediment-free water is transferred to a filtration process 360. The sedimentation 330 and filtration 360 processes are in fluid communication. The substantially sediment-free water is subjected to one or more filtering process to remove substantially most, if not all, particulates from the sediment-free water to form substantially particulate-free water in filtration process 360. Typically, the filtration process 360 comprises one or more of sand and/or gravel filter beds, carbon, charcoal and/or active carbon filters to name few. The substantially particle-free fee water is transferred to a disinfection process 340. The disinfection 340 and filtration 360 process are in fluid communication. The disinfection process can be any disinfection process. The disinfection process kills any bacteria and/or microorganism contained in the water to form drinking water.

Some municipal water treatment processes further include a fluorination and/or polishing processes (not depicted in FIG. 6) after the disinfection process 360. The after one or more of the disinfection 360 and one or both of the fluorination and polishing processes the drinking water is dispersed to the end-user.

In some embodiments, the rare earth-containing additive and/or cerium (IV) id contacted with the water prior to, during, or after the coagulation process 320. In some embodiments, the rare earth-containing additive and/or cerium (IV) is contacted with the water prior to, during, or after the sedimentation process 330. In some embodiments, the rare earth-containing additive and/or cerium (IV) is contacted with the water prior to, during, or after the filtration process 360.

In some embodiments, where the disinfection process comprises a disinfecting material that can be precipitated and/or sorbed by the rare earth-containing additive and/or cerium (IV) at least most, if not substantially all, of the rare earth-containing additive or cerium (IV) is remove from the water prior to the disinfection process 340. However, if the disinfection comprises a disinfecting material that is not substantially, or is not all, precipitated and/or sorbed by the rare earth-containing additive and/or cerium (IV) it is not necessary to remove them prior to the disinfecting process 340. Furthermore, in such instances, one or both of rare earth-containing additive and cerium (IV) may be may be contacted with the water prior to, during, or after the disinfection process 340.

Furthermore, when the water handling system 300 comprises a fluorination process it is desirous to remove at least most, if not substantially all, of the rare earth containing additive and/or cerium (IV) before the fluorination process. Rare earths typically form substantially insoluble-complexes with fluoride (F¹⁻) and can interfere with the fluorination process. Additionally, one or more steps, other than rare earth-containing additive addition and/or cerium (IV), can be omitted to meet the requirements of a specific application. Furthermore, the cerium (IV) may or may not formed by an in situ process any one or more of coagulation process 320, disinfection process 340, sedimentation process 330, and filtration process 360.

It can be appreciated that the contacting of the Ce (IV) and/or rare earth additive with the water prior to, during and/or after any one of providing step 310, coagulation step 320, sedimentation step 330, filtration step 360, disinfection step 340 and/or supplying drinking water 370 step substantially removes and/or sorbs at least one of a disinfection by-product, disinfection by-product precursor and target material. The removal and/or sorption of at least one of a disinfection by-product, disinfection by-product precursor and target material from the water forms purified water. The purified water has a reduced concentration, compared to the water, of the at least one of a disinfection by-product, disinfection by-product precursor and target material. Preferably, at least most of the at least one of a disinfection by-product, disinfection by-product precursor and target material is removed and/or sorbed from the water. That is, the purified water is substantially free of the at least one of a disinfection by-product, disinfection by-product precursor and target material.

As used herein cerium (III) may refer to cerium (+3), and cerium (+3) may refer to cerium (III). As used herein cerium (IV) may refer to cerium (+4), and cerium (+4) may refer to cerium (IV).

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

### Experiment 1

In a first set of experiments, water soluble CeCl₃ at either 1×10⁻³ or 1×10⁻⁴ M Ce³⁺ was contacted with an aqueous solution having one of 100 ppm, 10 ppm, or 0 ppm free chlorine. In each test, the reaction was allowed to stir overnight. Each test formed a precipitate which was filtered then analyzed by X-ray diffraction (“XRD”).

In each instance, the contacting of the water-soluble CeCl₃ with the aqueous solution yielded precipitates. X-ray diffraction analysis of the precipitates formed when 1×10⁻³ or 1×10⁻⁴ M Ce³⁺ was contacted with an aqueous solution containing 0 ppm free chlorine were similar to an x-ray diffraction pattern for La₂(CO₃)₃.8H₂O, as was the precipitate formed when 1×10⁻⁴ M Ce³⁺ was contacted with an aqueous solution containing 10 ppm free chlorine. However, the X-ray diffraction pattern for the precipitate formed when 1×10⁻³ M Ce³⁺ was contacted with an aqueous solution containing 100 ppm free chlorine was similar to that of cerium dioxide, CeO₂, (see FIG. 2). This indicates that cerium (III) was oxidized in the system. The pair of tests with the 1×10⁻⁴ mol/L Ce (III) did not show this effect, possibly due to the low concentration of free chlorine in that test (˜10 ppm, which is about the maximum for a pool, hot tub, or spa). Similar results are expected when Ce3+ is contacted with aqueous solutions having oxygen concentrations above about 1 ppm and bromine concentrations above about 10 ppm.

Experiment 2

In accordance with some embodiments, organic compounds and/or oxyanion forms of metals, metalloids, and non-metals may be removed from water by a rare earth-containing composition. Experiments were performed to remove organic and contaminants from de-ionized and NSF standardized waters (see Table 1).

TABLE 1

Removal Capacity (mg/g)

| Contaminant | DI | NSF |
|---|---|---|
| Arsenic (III) | 11.78 | 13.12 |
| Arsenic (V) | 0.86 | 7.62 |
| Chloride | | 163.68 |
| Fluoride | | 2.48 |
| Nitrate | | 0.00 |
| Phosphate | | 35.57 |
| Sulfate | | 46.52 |

In accordance with some embodiments, organic compounds and/or ionic forms of metals, metalloids, and non-metals may be removed from water by a rare earth-containing composition. Experiments were performed to qualitatively determine the removal of organic contaminants from de-ionized and NSF standardized waters (see Table 2).

TABLE 2

| | Can Be |
|---|---|
| | Removed From |
| Contaminant | DI Water |
| Phosphate | Removed |
| Chloroform | No Apparent |
| | Removal |
| Dimethylphosphinic Acid | Removed |
| Ethyl Methylphosphonate | No Apparent |
| | Removal |
| Malathion | No Apparent |
| | Removal |
| Phosphatidylcholine | Removed |
| Sodium Phosphonoformate | Removed |
| tribasic hexahydrate | |
| Triethyl phosphate | No Apparent |
| | Removal |
| Tris(dimethylamino) | Removed |
| phosphine | |

The NSF testing water composition in defined in one or more of the following documents: “NSF/ANSI 42-2007a NSF International Standard/American National Standard for Drinking Water Treatment Units—Drinking Water Treatment Units—Aesthetic Effects” Standard Developer—NSF International, Designated as a ANSI Standard, Oct. 22, 2007, American National Standards; “NSF/ANSI 53-2009e NSF International Standard/American National Standard Drinking Water Treatment Units—Health Effects” Standard Developer—NSF International, designated as an ANSI Standard, Aug. 28, 2009; and “NSF/ANSI 61-2009 NSF International Standard/American National Standard for Drinking Water Additives—Drinking Water System Components—Health Effects” Standard Developer NSF International, designated as an ANSI Standard, Aug. 26, 2009.

The constituents of a stock solution, in accordance with NSF P231 “general test water 2” (“NSF”), are shown in Tables 3-4:

TABLE 3
Amount of Reagents Added

| | | Amount of |
|---|---|---|
| | Amount of | Reagent Added to |
| | Reagent Added | 3.5 L (g) No |
| Compound | to 3.5 L (g) | Fluoride |
| NaF | 5.13 | 0 |
| AlCl₃•6H₂O | 0.13 | 0.13 |
| CaCl₂•2 H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 4
Calculated Analyte Concentrations

| | | Theoretical |
|---|---|---|
| | Theoretical | Concentration |
| | Concentration | (mg/L) No |
| Element | (mg/L) | Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

Furthermore, the rare earth-containing composition, may remove one or more of the following contaminants from water (as for example, de-ionized and NSF waters) chloroform, diazinon, dimethylphosphinic acid, ethyl methylphosphonate, glyphosate, malathion, phosphatidylcholine, phosphonoformates, triethyl phosphate and tris(dimethylamino)phosphine.

Experiment 3

Fifteen ml of CeO₂ was placed in a ⅞″ inner diameter column.

Six-hundred ml of influent containing de-chlorinated water and 3.5×10⁴/ml of MS-2 was flowed through the bed of CeO₂ at flow rates of 6 ml/min, 10 ml/min and 20 ml/min. Serial dilutions and plating were performed within 5 minutes of sampling using the double agar layer method with E. Coli, host and allowed to incubate for 24 hrs at 37° C.

The results of these samples are presented in Table 5.

TABLE 5

| Bed and | Influent | Effluent | Percent | |
|---|---|---|---|---|
| Flow Rate | Pop./ml | Pop/ml | reduction | Challenger |
| CeO₂ 6 ml/min | 3.5 × 10⁴ | 1 × 10⁰ | 99.99 | MS-2 |
| CeO₂ 10 ml/min | 3.5 × 10⁴ | 1 × 10⁰ | 99.99 | MS-2 |
| CeO₂ 20 ml/min | 3.5 × 10⁴ | 1 × 10⁰ | 99.99 | MS-2 |

Experiment 4

The CeO₂ bed treated with the MS-2 containing solution was upflushed. A solution of about 600 ml of de-chlorinated water and 2.0×10⁶/ml of Klebsiella terrgena was prepared and directed through the column at flow rates of 10 ml/min, 40 ml/min and 80 ml/min. The Klebsiella was quantified using the Idexx Quantitray and allowing incubation for more than 24 hrs. at 37° C.

The results of these samples are presented in Table 6.

TABLE 6

| Bed and | Influent | Effluent | Percent | |
|---|---|---|---|---|
| Flow Rate | Pop./ml | Pop/ml | reduction | Challenger |
| CeO₂ 10 ml/min | 2.0 × 10⁶ | 1 × 10⁻² | 99.99 | Klebsiella |
| CeO₂ 40 ml/min | 2.0 × 10⁶ | 1 × 10⁻² | 99.99 | Klebsiella |
| CeO₂ 80 ml/min | 2.0 × 10⁶ | 1 × 10⁻² | 99.99 | Klebsiella |

Experiment 5

The CeO₂ bed previously challenged with MS-2 and Klebsiella terrgena was then challenged with a second challenge of MS-2 at increased flow rates. A solution of about 1000 ml de-chlorinated water and 2.2×10⁵/ml of MS-2 was prepared and directed through the bed at flow rates of 80 ml/min, 120 ml/min and 200 ml/min. Serial dilutions and plating were performed within 5 minutes of sampling using the double agar layer method with E. Coli host and allowed to incubate for 24 hrs at 37° C.

The results of these samples are presented in Table 7.

TABLE 7

| Bed and | Influent | Effluent | Percent | |
|---|---|---|---|---|
| Flow Rate | Pop./ml | Pop/ml | reduction | Challenger |
| CeO₂ 80 ml/min | 2.2 × 10⁵ | 1 × 10⁰ | 99.99 | MS-2 |
| CeO₂ 120 ml/min | 2.2 × 10⁵ | 1.4 × 10² | 99.93 | MS-2 |
| CeO₂ 200 ml/min | 2.2 × 10⁵ | 5.6 × 10⁴ | 74.54 | MS-2 |

Experiment 6

ABS plastic filter housings (1.25 inches in diameter and 2.0 inches in length) were packed with ceric oxide (CeO₂) that was prepared from the thermal decomposition of 99% cerium carbonate. The housings were sealed and attached to pumps for pumping an aqueous solution through the housings. The aqueous solutions were pumped through the material at flow rates of 50 and 75 ml/min. A gas chromatograph was used to measure the final content of the chemical agent contaminant. The chemical agent contaminants tested, their initial concentration in the aqueous solutions, and the percentage removed from solution are presented in Table 8.

TABLE 8

| | | Starting | % | % |
|---|---|---|---|---|
| | | concentration | Removal at | Removal at |
| Common Name | Chemical Name | (mg/L) | 50 ml/min | 75 ml/min |
| VX | O-ethyl-S-(2-isopropylaminoethyl) | 3.0 | 99% | 97% |
| | methylphosphonothiolate | | | |
| GB (sarin) | Isopropyl | 3.0 | 99.9% | 99.7% |
| | methylphosphonofluoridate | | | |
| HD (mustard) | bis(2-chloroethyl)sulfide | 3.0 | 92% | 94% |
| Methamidophos | O,S-dimethyl | 0.184 | 95% | 84% |
| | phosphoramidothioate | | | |
| Monochrotophos | dimethyl (1E)-1-methyl-3- | 0.231 | 100% | 100% |
| | (methylamino)-3-oxo-1-propenyl | | | |
| | phosphate | | | |
| Phosphamidon | 2-chloro-3-(diethylamino)-1- | 0.205 | 100% | 95% |
| | methyl-3-oxo-1-propenyl dimethyl | | | |
| | phosphate | | | |

Experiment 9

A number of tests were undertaken to evaluate solution phase or soluble cerium ion precipitations.

### Test 1:

Solutions containing 250 ppm of fluoride were amended with cerium in 1:3 molar ratio of cerium:fluoride. Again the cerium was supplied as either Ce (III) chloride or Ce (IV) nitrate. While Ce (IV) immediately formed a solid precipitate with the fluoride, Ce (III) did not produce any visible fluoride solids in the pH range 3-4.5.

### Test 2:

Solutions containing 50 ppm of phosphate were amended with a molar equivalent of Ce (III) chloride. The addition caused the immediate precipitation of a solid. The phosphate concentration, as measured by ion chromatography, dropped to 20-25 ppm in the pH range 3-6.

### Experiment 10

These experiments examined the adsorption and desorption of a potassium permanganate.

Two experiments were performed. In the first experiment, 40 g of ceria powder were added to 250 mL of 550 ppm KMnO₄ solution. In the second experiment, 20 g of ceria powder were added to 250 mL of 500 ppm KMnO₄ solution and pH was lowered with 1.5 mL of 4 N HCl. Lowering the slurry pH increased the Mn loading on ceria four fold.

In both experiments the ceria was contacted with permanganate for 18 hours then filtered to retain solids. The filtrate solutions were analyzed for Mn using ICP-AES, and the solids were washed with 250 mL of DI water. The non-pH adjusted solids were washed a second time.

Filtered and washed Mn-contacted solids were weighed and divided into a series of three extraction tests and a control. These tests examined the extent to which manganese could be recovered from the ceria surface when contacted with 1 N NaOH, 10% oxalic acid, or 1 M phosphate, in comparison to the effect of DI water under the same conditions.

The sample of permanganate-loaded ceria powder contacted with water as a control exhibited the release of less than 5% of the Mn. As with arsenate, NaOH effectively promoted desorption of permanganate from the ceria surface. This indicates that the basic pH level, or basification, acts as an interferer to permanganate removal by ceria. In the case of the second experiment, where pH was lowered, the effect of NaOH was greater than in the first case where the permanganate adsorbed under higher pH conditions.

Phosphate was far more effective at inducing permanganate desorption than it was at inducing arsenate desorption. Phosphate was the most effective desorption promoter we examined with permanganate. In other words, the ability of the ceria powder to remove permanaganate in the presence of phosphate appears to be relatively low as the capacity of the ceria powder for phosphate is much higher than for permanganate.

Oxalic acid caused a significant color change in the permanganate solution, indicating that the Mn(VII) was reduced, possibly to Mn(II) or Mn(IV), wherein the formation of MnO or MnO₂ precipitates would prevent the detection of additional Mn that may or may not be removed from the ceria. A reductant appears therefore to be an interferer to ceria removal of Mn(VII). In the sample that received no pH adjustment, no desorbed Mn was detected. However, in the sample prepared from acidifying the slurry slightly a significant amount of Mn was recovered from the ceria surface.

Table 9 shows the test parameters and results.

TABLE 9
Loading and extraction of other adsorbed elements
from the ceria surface (extraction is shown for each
method as the ‘percent loaded that is recovered)

| | Per- | Per- |
|---|---|---|
| | manganate | manganate |
| loading pH | 6 | 11 |
| loading (mg/g) | 4 | 0.7 |
| water (% rec) | 2.6 | 3.4 |
| 1N NaOH (% rec) | 49.9 | 17.8 |
| 10% oxalic (% rec) | 22.8 | <3 |
| 0.5M PO4 (% rec) | 78.6 | 45.8 |
| 30% H2O2 (% rec) | | |

Experiment 11

A series of isotherms were prepared using the following procedure. 20 mg of Molycorp HSA cerium oxide was measured out in a plastic weigh boat. The media was wetted with DI water for at least 30 minutes. Influent was prepared in 2.5 L batches in either DI or NSF 53 arsenic removal water without added arsenic. 500 mg/L stock solutions were prepared from solid reagents or 1000 mg/L SPEX standards were obtained and were used to prepare 0.5 mg/L influents of the reagents in question. 500 mL of influent was poured into 4 500 mL bottles. Each bottle was either labeled as a sample or a control. The previously prepared media was poured into each sample bottle. Bottles were capped and sealed with electrical tape. Each bottle was then placed within a rolling container that could hold up to 10 bottles. The containers were then sealed with duct tape and placed on the rolling apparatus. Samples and controls were rolled for 24 hours. After 24 hours, the rolling containers were removed from the apparatus and the bottles were retrieved from the containers. A 10-45 mL sample of each solution was taken and filtered with a 0.2 μm filter. Samples were analyzed by a HACH colorimeter using the HACH total phosphorus test kit.

The results are presented in Table 10 below:

TABLE 10

| | | | | | | Removal Capacity | |
|---|---|---|---|---|---|---|---|
| | | Can Be removed | | Percent Removal | | (mg/g) | |
| | | DI | NSF | DI | NSF | DI | NSF |
| Phospho- | Cyclophosphamide | I | N/A | 0.0 | N/A | N/A | N/A |
| organics | Diazinon | I | N/A | 0.0 | N/A | N/A | N/A |
| | Dimethylphosphinic Acid | Yes | N/A | 10.9 | N/A | 1.5 | N/A |
| | Ethyl Methylphosphonate | I | N/A | 0.0 | N/A | N/A | N/A |
| | Glyphosate | Yes | N/A | 32.5 | N/A | 12.1 | N/A |
| | Malathion | I | N/A | 0.0 | N/A | N/A | N/A |
| | Phosphatidylcholine | I | N/A | 0.0 | N/A | N/A | N/A |
| | Sodium Phosphonoformate | Yes | N/A | 13.3 | N/A | 5.6 | N/A |
| | tribasic hexahydrate | | | | | | |
| | Triethyl phosphate | I | N/A | 0.0 | N/A | N/A | N/A |
| | Tris(dimethylamino) | Yes | N/A | 37.9 | N/A | 29.9 | N/A |
| | phosphine | | | | | | |

I—Inconclusive

Experiment 12

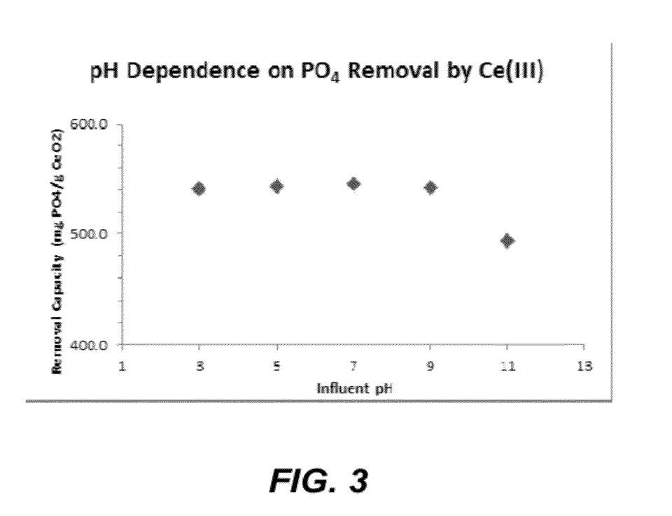

A series of tests were performed to determine the pH dependence on phosphate removal by cerium (III). Various compounds can form between a trivalent rare earth (“RE”) and phosphate anion, namely RE(PO₄), RE₂(HPO₄)₃ and RE(H₂PO₄)₃. While not wishing to be bound by any theory, it is believed that, when cerium (III) is contacted with a phosphate-containing solution, a mixture of these phases results. The results are presented in FIG. 3.

FIG. 3 shows that these phases do not seem to be significantly soluble between pH 3-11. In fact, Ce (III) maintains very good PO4 removal capacity over that pH range in a distilled water system with H₃PO₄ (1 g/L) and HEPES buffer (12 mM).

Experiment 13

A series of tests were performed to determine contaminant removal using insoluble cerium oxide. The tests entailed pumping an influent solution of HEPES buffered DI water and a contaminant concentration from about 200 to about 600 ppm through a bed of cerium oxide (CeO₂). Bed dimensions were determined by set-up in a 1 cm column. The bed volume was about 5 mLs. Influent was pumped through the bed at a rate of 0.25 bed volume per minute or about 1.25 mLs per minute. Effluent samples were collected with a fraction collector and analyzed for contaminant with an appropriate analytical method. Sample collection times were approximately every 0.5 hour. The results are summarized in Table &&%%. For each of the contaminants, cerium oxide was able to removal from 75 to about 100% of the contaminant from the aqueous solution before breakthrough.

TABLE 11
Cerium oxide (CeO₂)

| Contaminant | Di Water |
|---|---|
| Dibromochloromethane | Removed |
| Methyl t-butyl ether | Removed |
| Acetaldehyde | Removed |
| Chloroacetic Acid | Removed |

Experiment 14

A series of tests were performed to determine contaminant removal using soluble cerium. The soluble cerium tested was cerium (III) chloride, CeCl₃. Four 500 mL aqueous samples having a contaminant concentration from about 200 to about 600 ppm were prepared. All four samples were stirred on a stir plate at 200 RPM. Three samples were treated with a cerium chloride solution (about 0.3 M in cerium (III) chloride). In the treated solution, the molar ratio of cerium chloride to the contaminant was about one to one. The cerium chloride was added while the samples were being stirred. One sample, the control, was not treated with cerium chloride. The samples were stirred for about 2 hours. After a 2 hour stir period, the samples were withdrawn and filtered using a 0.1 micrometer syringe filter. The filtered samples were analyzed for their level of contaminant in solution using an appropriate analytical technique.

Tests were run in two matrices, DI water buffered with HEPES and an NSF 53 based matrix. The NSF matrix contained sodium silicate (94.7 ppm), sodium carbonate (250.0 ppm), magnesium sulfate (128.0 ppm), sodium nitrate (12.0 ppm), sodium phosphate (0.2 ppm), calcium chloride (148.2 ppm) and sodium fluoride (2.2 ppm). In the case of experiments run using NSF influent, the CeCl₃ concentration was determined using equivalent molar concentration of the analyte and also carbonate, sulfate, sodium fluoride and phosphate. This is to counteract the buffering effect of these compounds and keep test data for NSF water based influent and DI water based influent comparable. Contaminant removal is summarize in Table 12.

TABLE 12
Cerium Chloride (CeCl₃)

| Contaminant | DI Water | NST 53 Water |
|---|---|---|
| Dibromochloromethane | Not removed | Not removed |
| Nitrosodimethylamine | Not removed | Not removed |
| Methyl t-butyl ether | Not removed | Not removed |
| Acetaldehyde | Not removed | Not removed |
| Chloroacetic Acid | Not removed | Removed |

A number of variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate common embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving a water containing at least one of a disinfection by-product and a disinfection by-product precursor; and
contacting the water with a rare earth-containing additive to remove at least one of the disinfection by-product and disinfection by-product precursor from the water and form a treated water.

2. The method of claim 1, wherein the rare earth-containing additive removes at least most of the disinfection by-product, wherein the water contains a halogenated disinfectant, wherein the disinfection by-product comprise one of a trihalomethane, haloacetic acid, haloacetonitrile, halofuranone, bromate, halonitromethane, haloamide, iodo-acid, iodo-trihalomethane, nitrosamine, and dihaloaldehyde, and wherein the rare earth-containing additive comprises a water soluble cerium (III) salt.

3. The method of claim 1, wherein the rare earth-containing additive removes at least most of the disinfection by-product, wherein the water contains a halogenated disinfectant, wherein the disinfection by-product comprises one of a trihalomethane, haloacetic acid, haloacetonitrile, halofuranone, bromate, halonitromethane, haloamide, iodo-acid, iodo-trihalomethane, nitrosamine, and dihaloaldehyde, and wherein the rare earth-containing additive comprises a cerium (IV)-containing composition.

4. The method of claim 1, wherein the rare earth-containing additive removes at least most of the disinfection by-product precursor, wherein the disinfection by-product precursor is one or more of t-butyl methyl ether, diazomethane, hypohalous acid, aldehyde, carboxylic acid, and chloramines.

5. The method of claim 1, wherein the rare earth-containing additive removes at least most of target material contained in the water, the target material comprising one or more of alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

6. A method, comprising:
receiving a water containing at least one of a disinfection by-product, disinfection by-product precursor and a target material; and
contacting the water with a rare earth additive to remove at least one of disinfection by-product, disinfection by-product precursor and a target material from the water, the rare earth the rare earth additive comprises at least one of cerium (IV)-containing composition and a water soluble trivalent rare-earth containing composition.

7. The method of claim 6, wherein the target material comprise one or both of a phosphate and an organophosphate, wherein the cerium (IV)-containing composition is water insoluble, wherein the trivalent rare earth-containing composition comprises primarily a cerium (III) salt, and wherein the rare earth additive has a molar ratio of the water soluble trivalent rare earth-containing composition to the cerium (IV) containing composition of no more than about 1:0.5.

8. The method of claim 6, wherein the cerium (IV)-containing composition comprises cerium oxide (CeO₂).

9. The method of claim 8, wherein the disinfection by-product comprises one or more of halomethane and halogenated carboxylic acid.

10. The method of claim 8, wherein the disinfection by-product precursor comprises one or more of an aldehyde, carboxylic acid and ether.

11. The method of claim 6, wherein the target material comprises one or more of alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

12. The method of claim 6, wherein the contacting step further comprises contacting a water soluble cerium (III)-containing additive with the water and wherein the cerium (IV)-containing composition is formed in the water by at least one of the following steps:
(i) contacting the cerium (III)-containing additive with ozone;
(ii) contacting the cerium (III)-containing additive with ultraviolet radiation;
(iii) electrolyzing the cerium (III)-containing additive;
(iv) contacting the cerium (III)-containing additive with free oxygen and hydroxyl ions;
(v) aerating the cerium (III)-containing additive with molecular oxygen; and
(vi) contacting the cerium (III)-containing additive with an oxidant, the oxidant being one or more of chlorine, bromine, iodine, chloroamine, chlorine dioxide, hypochlorite, trihalomethane, haloacetic acid, hydrogen peroxide, peroxygen compound, hypobromous acid, bromoamine, hypobromite, hypochlorous acid, isocyanurate, tricholoro-s-triazinetrione, hydantoin, bromochloro-dimethyldantoin, 1-bromo-3-chloro-5,5-dimethyldantoin, 1,3-dichloro-5,5-dimethyldantoin, sulfur dioxide, bisulfate, and monopersulfate.

13. The method of claim 6, wherein the rare earth additive comprises a water soluble trivalent rare earth-containing composition and a nitrogen-containing material.

14. A composition, comprising:
a rare earth; and
an oxyanion, wherein a molar ratio of the rare earth to oxyanion of about 1:1.3 to about 1:2.6.

15. The composition of claim 14, wherein the rare earth is cerium and the oxyanion is phosphate.

16. A human bathing system, comprising:
a rare earth-containing additive; and
a water recirculation system operable to treat and recirculate water to the at least one of a pool, spa, and hot tub, wherein:
the water is substantially free of a halogenated antimicrobial additive;
the rare earth-containing additive removes phosphates and microbes from the re-circulated water.

17. The system of claim 16, wherein the rare earth-containing additive comprises cerium (IV) oxide.

18. The system of claim 16, wherein the rare earth-containing additive removes one or both of sun tan oils and body oils.

19. The system of claim 16, further comprising:
one or both of make-up and fill-waters to one of fill or replenish the human bathing system, wherein one or both of the make-up and fill-waters contain at least one target material, wherein the rare earth-containing additive removes at least most of the least one target material.

20. The system of claim 19, wherein the at least one target material comprises one or more of a disinfection by-product, a disinfection by-product precursor, a phosphate, oxyanion, organophosphate, trihalomethane, iodo-triahlomethane, haloacetic acid, halofuranone, bromate, halonitromethane, haloamide, iodo-acid, nitrosamine, dihaloaldehyde, alachor (or 2-chloro-N-(2,6-diethylpheynyl)-N-(methoxymethyl)acetamide), benzo[a]pyrene, chlordane (or octachloro-4,7-methanohydroindane), 2,4-D (or 2,4-dichlorophenoxy)acetic acid), dalapon (or CH₃C(Cl)₂CO₂H), bis(2-ethylhexyl adipate (or hexanedioic acid bis(2-ethylhexyl) ester), endothal (or 7-oxabicyclo[2.2.1]heptane-2,3-dicarboxylic acid), oxamyl (or Vydate), picloram (or 4-amino-3,5,6-trichloro-2-pyridinecarboxylic acid), simazine (or 6-chloro-N,N′-dietyl-1,3,5-triazine-2,4-diamine), halogentate methane, trihalomethane, chloramine, toxaphene, trihalomethane, endrin, heptachlor, hexachlorocyclopentadiene, hexachlorobutadiene, lindane, aldrin, dieldrin, halogenated acetic acid, trihaloacetic acid, trichloroacetic acid, tribromoacetic acid, triiodoacetic acid, dicamba, and toxaphen.

21. The system of claim 19, wherein the rare earth-containing additive comprises water-insoluble cerium (IV).

22. The system of claim 21, wherein the water-insoluble cerium (IV) comprises cerium oxide (CeO₂).
